(19) United States
(12) Patent Application Publication
(10) Pub. No.: US 2010/0253659 A1
(43) Pub. Date: Oct. 7, 2010

(54) DISPLAY APPARATUS AND DRIVING METHOD FOR DISPLAY APPARATUS

(75) Inventors: Hideki Sugimoto, Kanagawa (JP); Katsuhide Uchino, Kanagawa (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/729,681

(22) Filed: Mar. 23, 2010

(30) Foreign Application Priority Data
Apr. 2, 2009 (JP) 2009-090076

(51) Int. Cl. G06F 3/038

(52) U.S. Cl. 345/206; 345/212

(57) ABSTRACT

Disclosed herein is a driving method for a display apparatus which includes: (1) a scanning line; (2) a data line; (3) a display element; (4) a feeder line; (5) a current detection line; and (6) a switching element, the driving method for a display apparatus including a current detection step of placing the switching element into an on state in a state wherein a potential of the current detection line is maintained so that a potential difference between the second end of a light emitting element and the current detection line does not exceed a threshold voltage of the light emitting element and supplying current flowing through a driving transistor to the current detection line so as to be detected.

### BACKGROUND OF THE INVENTION

1. Field of the Invention

This invention relates to a display apparatus and a driving method for a display apparatus.

2. Description of the Related Art

A display element having a light emitting element of the current driven type and a display apparatus including such display elements are known. For example, a display element having an electroluminescence light emitting element which utilizes electroluminescence (hereinafter referred to sometimes as EL in abbreviation) of an organic material attracts attention as a display element which emits light of high luminance by low-voltage dc driving. It is to be noted that a display element of the type described is hereinafter referred to sometimes as organic EL display element.

Similarly as in a liquid crystal display apparatus, for example, also in a display apparatus including an organic EL display element (a display apparatus of the type is hereinafter referred to sometimes as organic EL display apparatus), a simple matrix method and an active matrix method are well known as a driving method. Although the active matrix method has a drawback that the structure is complicated, it has such an advantage that an image can be displayed with a high luminance. An organic EL display apparatus which is driven by the active matrix method includes, in addition to a light emitting element formed from an organic layer including a light emitting layer or like, a driving circuit for driving the light emitting element.

As a circuit for driving an organic electroluminescence light emitting element, which is hereinafter referred to sometimes as light emitting element in abbreviation, a driving circuit including two transistors and one capacitive element, called 2Tr/1C driving circuit, is known and disclosed in, for example, Japanese Patent Laid-Open No. 2007-310311. The 2Tr/1C driving circuit is shown in FIG. 2. Referring to FIG. 2, the 2Tr/1C driving circuit shown includes two transistors including a writing transistor TR_{W} and a driving transistor TR_{D} and further includes a single capacitive element C₁. One of source/drain regions of the driving transistor TR_{D} forms a second node ND₂ and the gate electrode of the driving transistor TR_{D} forms a first node ND₁.

The light emitting element ELP is connected at the cathode electrode thereof to a second feeder line PS2. A voltage V_{Cat} which is, for example, 0 volt is applied to the second feeder line PS2.

Operation of the 2Tr/1C driving circuit is illustrated in a timing chart of FIG. 7. Referring to FIG. 7, a pre-process for carrying out a threshold voltage cancellation process is executed within a period TP(2)_{1A}. In particular, a first node initializing voltage V_{Ofs}, which is, for example, 0 volt, is applied to the first node ND₁ from a data line DTL through the writing transistor TR_{W} which has been placed into an on state by a scanning signal from a scanning line SCL. Consequently, the potential at the first node ND₁ becomes equal to the first node initializing voltage V_{Ofs}. Further, a second node initializing voltage V_{CC-L}, such as, for example −10 volt is applied from a power supply section 100 to the second node ND₂ through a feeder line PS1 and the driving transistor TR_{D}. Consequently, the potential at the second node ND₂ becomes equal to the second node initializing voltage V_{CC-L}. The threshold voltage of the driving transistor TR_{D} is represented as Vₜₕ and is, for example, 3 volt. The potential difference between the gate electrode and a second one (which is sometimes referred to conveniently as source region) of the source/drain regions of the driving transistor TR_{D} is greater than the threshold voltage Vₜₕ, and the driving transistor TR_{D} is in an on state.

Then, within a period TP(2)_{1B} to another period TP(2)₅, a threshold voltage cancellation process is carried out. In particular, within the period TP(2)_{1B}, a first time threshold voltage cancellation process is carried out. Within the period TP(2)₃, a second time threshold voltage cancellation process is carried out, and thereafter, within the period TP(2)₅, a third time threshold voltage cancellation process is carried out.

Within the period TP(2)_{1B}, while the on state of the writing transistor TR_{W} is maintained, the voltage of the power supply section 100 is changed over from the second node initializing voltage V_{CC-L} to a driving voltage V_{CC-H} which is, for example, 20 volt. As a result, the potential at the second node ND₂ varies toward a potential calculated by subtracting the threshold voltage Vₜₕ of the driving transistor TR_{D} from the potential of the first node ND₁. In other words, the potential at the second node ND₂ rises.

If this period TP(2)_{1B} is sufficiently long, then the potential difference between the gate electrode and the second one of the source/drain regions of the driving transistor TR_{D} reaches Vₜₕ, and the driving transistor TR_{D} is placed into an off state. In other words, the potential at the second node ND₂ approaches and finally becomes the difference V_{Ofs}−Vₜₕ. However, in the example illustrated in FIG. 7, the length of the period TP(2)_{1B} is insufficient to sufficiently vary the potential at the second node ND₂, and at the end stage of the period TP(2)_{1B}, the potential at the second node ND₂ reaches a certain potential V₁ which satisfies a relation of V_{CC-L}<V₁<(V_{Ofs}−Vₜₕ).

At the initial stage of the period TP(2)₂, the voltage of the data line DTL changes over from the first node initializing voltage V_{Ofs} to a video signal V_{Sig}_{_{—}}ₘ₋₂. The writing transistor TR_{W} is placed into an off state with a signal from the scanning line SCL at the initial stage of the period TP(2)₂ so that the video signal V_{Sig}_{_{—}}ₘ₋₂ may not be applied to the first node ND₁. As a result, the first node ND₁ enters a floating state.

Since the driving voltage V_{CC-H} is applied from the power supply section 100 to a first one of the source/drain regions of the driving transistor TR_{D} through the feeder line PS1, the potential at the second node ND₂ rises from the potential V₁ to a certain potential V₂. On the other hand, since the gate electrode of the driving transistor TR_{D} is in a floating state and the capacitive element C₁ exists, a bootstrap operation occurs with the gate electrode of the driving transistor TR_{D}. Accordingly, the potential at the first node ND₁ rises following up the potential variation at the second node ND₂.

At the start timing of the period TP(2)₃, the voltage of the data line DTL changes over from the video signal V_{Sig}_{_{—}}ₘ₋₂ to the first node initializing voltage V_{Ofs}. At the start timing of the period TP(2)₃, the writing transistor TR_{W} is placed into an on state in response to a signal from the scanning line SCL. As a result, the potential at the first node ND₁ becomes equal to V_{Ofs}. Further, the driving voltage V_{CC-H} is applied from the power supply section 100 to the first one of the source/drain regions of the driving transistor TR_{D} through the feeder line PS1. As a result, the potential at the second node ND₂ varies toward a potential calculated by subtracting the threshold voltage Vₜₕ of the driving transistor TR_{D} from the potential at the first node ND₁. In particular, the potential at the second node ND₂ rises from the potential V₂ to a certain potential V₃.

At the start timing of the period TP(2)₄, the voltage of the data line DTL changes over from the first node initializing voltage V_{Ofs} to a video signal V_{Sig}_{_{—}}ₘ₋₁. The writing transistor TR_{W} is placed into an off state in response to a signal from the scanning line SCL at the start timing of the period TP(2)₄ so that the video signal V_{Sig}_{_{—}}ₘ₋₁ is not applied to the first node ND₁. As a result, the first node ND₁ enters a floating state.

Since the driving voltage V_{CC-H} is applied from the power supply section 100 to the first one of the source/drain regions of the driving transistor TR_{D} through the feeder line PS1, the potential at the second node ND₂ rises from the potential V₃ to a certain potential V₄. On the other hand, since the gate electrode of the driving transistor TR_{D} is in a floating state and the capacitive element C₁ exists, a bootstrap operation occurs with the gate of the driving transistor TR_{D}. Accordingly, the potential at the first node ND₁ rises following up the potential variation at the second node ND₂.

As a prerequisite for operation within the period TP(2)₅, it is necessary for the potential V₄ at the second node ND₂ to be lower than the potential difference V_{Ofs} Vₜₕ at the start timing of the period TP(2)₅. The length from the start timing of the period TP(2)_{1B} to the start stage of the period TP(2)₅ is determined so as to satisfy a condition of V₄<V_{Ofs-L}−Vₜₕ.

Operation within the period TP(2)₅ is basically similar to that described hereinabove in regard to the period TP(2)₃. At the initial stage of the period TP(2)₅, the voltage of the data line DTL changes over from the video signal V_{Sig}_{_{—}}ₘ₋₁ to the first node initializing voltage V_{Ofs}. At an initial stage of the period TP(2)₅, the writing transistor TR_{W} is placed into an on state with a signal from the scanning line SCL.

The first node ND₁ is placed into a state wherein the first node initializing voltage V_{Ofs} is applied thereto from the data line DTL through the writing transistor TR_{W}. Further, the driving voltage V_{CC-H} is applied from the power supply section 100 to the first one of the source/drain regions of the driving transistor TR_{D} through the feeder line PS1. Similarly as in the description given hereinabove in connection with the period TP(2)₃, the potential at the second node ND₂ varies toward the potential calculated by subtracting the threshold voltage Vₜₕ of the driving transistor TR_{D} from the potential at the first node ND₁. Then, when the potential difference between the gate voltage and the second one of the source/drain regions of the driving transistor TR_{D} reaches the voltage Vₜₕ, the driving transistor TR_{D} is placed into an off state. In this state, the potential at the second node ND₂ is substantially equal to the difference V_{Ofs}−Vₜₕ.

Thereafter, within the period TP(2)_{6A}, the writing transistor TR_{W} is placed into an off state. Then, the voltage of the data line DTL is changed to a voltage corresponding to the video signal, that is, a video signal or luminance signal V_{Sig}_{_{—}}ₘ for controlling the luminance of the light emitting element ELP.

Thereafter, within a period TP(2)_{6B}, a writing process is carried out. In particular, the scanning line SCL is placed into a high level state to place the writing transistor TR_{W} into an on state. As a result, the potential at the first node ND₁ rises to the video signal V_{Sig}_{_{—}}ₘ.

In the operation described above, the video signal V_{Sig}_{_{—}}ₘ is applied to the gate electrode of the driving transistor TR_{D} in a state wherein the driving voltage V_{CC-H} is applied to the first one of the source/drain regions of the driving transistor TR_{D}. Therefore, the potential at the second node ND₂ rises within the period TP(2)_{6B} as seen in FIG. 7. The rise amount ΔV, which is a potential correction value, of the potential in this instance is hereinafter described. Where the potential at the gate electrode of the driving transistor TR_{D}, that is, at the first node ND₁, is represented by V_{g} and the potential at the second one of the source/drain regions of the driving transistor TR_{D}, that is, at the second node ND₂, is represented by Vₛ, if the rise amount ΔV of the potential at the second node ND₂ described above is not taken into consideration, then the potential V_{g} and the potential Vₛ exhibit such values as described below. In particular, the potential difference between the first node ND₁ and the second node ND₂, that is, the potential difference V_{gs} between the gate electrode of the driving transistor TR_{D} and the second one of the source/drain regions which operates as the source region can be represented by the following expression (A):

V_{g}=V_{Sig}_{_{—}}ₘ

Vₛ≈V_{Ofs}−Vₜₕ

V_{gs}≈V_{Sig}_{_{—}}ₘ−(V_{Ofs}−Vₜₕ) (A)

In particular, the potential difference V_{gs} obtained by the writing process for the driving transistor TR_{D} relies only upon the video signal V_{Sig}_{_{—}}ₘ for controlling the luminance of the light emitting element ELP, the threshold voltage Vₜₕ of the driving transistor TR_{D} and the first node initializing voltage V_{Ofs} for initializing the potential of the gate electrode of the driving transistor TR_{D}. In other words, the potential difference V_{gs} is independent of the threshold voltage V_{th-EL} of the light emitting element ELP.

Now, a mobility correction process is described briefly. In the operation described above, a mobility correction process of varying the potential of the second one of the source/drain regions of the driving transistor TR_{D}, that is, the potential at the second node ND₂, is carried out in response to a characteristic of the driving transistor TR_{D}, for example, in response to the magnitude of the mobility μ in the writing process.

As described hereinabove, the video signal V_{Sig}_{_{—}}ₘ is applied to the gate electrode of the driving transistor TR_{D} in a state wherein the driving voltage V_{CC-H} is applied to the first one of the source/drain regions of the driving transistor TR_{D}. Here, the potential at the second node ND₂ rises within the period TP(2)_{6B} as seen in FIG. 7. As a result, where the value of the mobility μ of the driving transistor TR_{D} is high, the rise amount ΔV, which is a potential correction value, of the potential in the source region of the driving transistor TR_{D} is great. However, where the value of the mobility μ of the driving transistor TR_{D} is low, the rise amount ΔV, which is a potential correction value, of the potential in the source region of the driving transistor TR_{D} is small. The potential difference V_{gs} between the gate electrode and the source region of the driving transistor TR_{D} is transformed from the expression (A) into the following expression (B):

V_{gs}≈V_{Sig}_{_{—}}ₘ−(V_{Ofs}−Vₜₕ)−ΔV (B)

By the operation described above, the threshold voltage cancellation process, writing process and mobility correction process are completed. Then, at the initial stage of a period TP(2)_{6C}, the writing transistor TR_{W} is placed into an off state with a scanning signal from the scanning line SCL to place the first node ND₁ into a floating state. The first one of the source/drain regions of the driving transistor TR_{D} which may be hereinafter referred to as drain region for the convenience of description is placed in a state wherein the driving voltage V_{CC-H} is applied thereto. As a result, the potential at the second node ND₂ rises, and a phenomenon similar to that which occurs with a bootstrap circuit occurs with the gate electrode of the driving transistor TR_{D}, and also the potential at the first node ND₁ rises. The potential difference V_{gs} between the gate electrode and the source region of the driving transistor TR_{D} maintains the value of the expression (B). The current flowing through the light emitting element ELP is drain current I_{ds} which flows from the drain region to the source region of the driving transistor TR_{D}. If it is assumed that the driving transistor TR_{D} operates ideally within a saturation region, then the drain current I_{ds} can be represented by the following expression (C):

$$\begin{matrix}{I}_{ds} = k \cdot μ \cdot {( {V}_{gs} - {V}_{th} )}^{2} \\ = k \cdot μ \cdot {( {V}_{Sig \_ m} - {V}_{Ofs} - Δ V )}^{2}\end{matrix} \qquad ( C )$$

The light emitting element ELP emits light with a luminance corresponding to the value of the drain current I_{ds}. The coefficient k is hereinafter described.

From the expression (C) above, the drain current I_{ds} increases in proportion to the mobility μ. On the other hand, as the mobility μ of the driving transistor TR_{D} increases, the potential correction amount ΔV increases and the value of (V_{Sig}_{_{—}}ₘ−V_{Ofs}−ΔV)² in the expression (C) decreases. A dispersion of the drain current I_{ds} arising from a dispersion of the mobility μ of the driving transistor can be corrected by this.

Also operation of the 2Tr/1C driving circuit whose outline is described above is hereinafter described in detail.

### SUMMARY OF THE INVENTION

According to the operation described above, a dispersion of the luminance arising from a characteristic variation of a driving transistor can be corrected by the threshold voltage cancellation process and the mobility correction process. However, for example, if a threshold value characteristic of a writing transistor changes as time passes, then the time for carrying out a writing process varies and the potential correction value ΔV by mobility correction varies. Consequently, a variation appears with the drain current of the driving transistor. In this manner, the value of current to flow through the light emitting element varies as time passes from various factors, and as a result, also the luminance of the light emitting element varies as time passes. In order to accurately grasp the secular change described above, it is necessary to detect current without disturbing operation of the threshold voltage cancelation process and the mobility correction process.

Therefore, it is desirable to provide a display apparatus and a driving method for a display apparatus wherein current flowing to a light emitting element can be detected without disturbing a threshold voltage cancellation process or a mobility correction process.

According to the embodiments of the present invention, a display apparatus and a display apparatus for use with a driving method for a display apparatus includes:

(1) a scanning line connected to a scanning circuit and extending in a first direction;

(2) a data line connected to a signal outputting circuit and extending in a second direction;

(3) a display element including a current-driven type light emitting element and a driving circuit;

(4) a feeder line connected to a power supply section and extending in the first direction;

the driving circuit which composes the display element including a writing transistor, a driving transistor and a capacitive element;

the driving transistor being configured such that

(A-1) a first one of source/drain regions is connected to the feeder line; that

(A-2) a second one of the source/drain regions is connected to an end of the light emitting element and also to a first one of electrodes of the capacitive element and forms a second node; and that

(A-3) the gate electrode is connected to the second one of the source/drain regions of the writing transistor and also to a second one of the electrodes of the capacitive element and forms a first node;

the writing transistor being configured such that

(B-1) a first one of source/drain regions is connected to the data line; and that

(B-2) the gate electrode is connected to the scanning line;

the display apparatus further including

(5) a current detection line extending in the second direction; and

(6) a switching element disposed between the second node and the current detection line.

According to the embodiments of the present invention, the driving method for a display apparatus includes a current detection step of placing the switching element into an on state in a state wherein a potential of the current detection line is maintained so that a potential difference between the second end of the light emitting element and the current detection line does not exceed a threshold voltage of the light emitting element and supplying current flowing through the driving transistor to the current detection line so as to be detected.

With the driving method for a display apparatus, current to flow to the light emitting element through the driving transistor can be supplied to the current detection line and detected without being supplied to the light emitting element. Consequently, the detection of current can be carried out without disturbing a threshold voltage cancellation process or a mobility correction process. The driving method for a display apparatus may further include the step of controlling a value of a video signal to be applied to the data line based on a value of the current detected at the current detection step. With a display apparatus which incorporates the driving method for a display apparatus, a good image displaying characteristic can be maintained.

The above and other aims, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a circuit diagram of a display apparatus according to an embodiment of the present invention;

FIG. 2 is an equivalent circuit diagram of a display element including a driving circuit in the display apparatus of FIG. 1;

FIG. 3 is a schematic sectional view of part of the display apparatus of FIG. 1;

FIG. 4 is a timing chart illustrating driving of the display element shown in FIG. 2;

FIG. 5 is a timing chart of detection current in the display apparatus of FIG. 1;

FIG. 6 is a circuit diagram of a display apparatus of a reference example;

FIG. 7 is a timing chart illustrating driving of a display element in the display apparatus of FIG. 6;

FIGS. 8A to 8F and 9A to 9F are circuit diagrams schematically illustrating on/off stages and so forth of transistors of a driving circuit for a display element in the display apparatus of FIG. 6;

FIGS. 10A to 10C, 11A to 11C and 12 are circuit diagrams schematically illustrating on/off states and so forth of transistors and switching members which form a driving circuit for a display element in the display apparatus of FIG. 6 and illustrating a current detection step;

FIG. 13 is a timing chart illustrating driving of a display element according to an embodiment 2 of the present invention;

FIGS. 14A to 14C are circuit diagrams schematically illustrating on/off states and so forth of transistors and switching members which form a driving circuit for the display element shown in FIG. 13 and illustrating a current detection step;

FIG. 15 is a timing chart illustrating driving of a display element according to an embodiment 3 of the present invention;

FIGS. 16A to 16C are circuit diagrams schematically illustrating on/off states and so forth of transistors and switching members which form a driving circuit for the display element shown in FIG. 15 and illustrating a current detection step; and

FIGS. 17, 18 and 19 are equivalent circuit diagrams of display elements each including a driving circuit.

### DETAILED DESCRIPTION OF THE PREFERRED EMBODIMENTS

In the following, the present invention is described in detail in connection with preferred embodiments thereof. It is to be noted that the description is given in the following order.

1. More detailed description of the display apparatus and the driving method for a display apparatus according to the embodiments of the present invention

2. Description of an outline of the display apparatus used in the embodiments

3. Embodiment 1

4. Embodiment 2

5. Embodiment 3

### 1. More Detailed Description of the Display Apparatus and the Driving Method for a Display Apparatus According to the Embodiments of the Present Invention

In the driving method for a display apparatus according to the embodiments of the present invention, the driving method for a display apparatus may further include the steps of:

(a) carrying out a pre-process for initializing a potential at the first node and a potential at the second node so that a potential difference between the first node and the second node exceeds a threshold voltage of the driving transistor and a potential difference between the second node and the second end of the light emitting element does not exceed the threshold voltage of the light emitting element;

(b) carrying out a threshold voltage cancellation process for varying the potential at the second node toward a potential calculated by subtracting the threshold voltage of the driving transistor from the potential at the first node in a state wherein the potential at the first node is maintained; and

(c) applying a reference voltage to the first node;

the current detection step being carried out after the step (c).

In this instance, the driving method for a display apparatus may include, in place of the step (c), the steps of:

(c-1) carrying out a writing process for applying a video signal from the data line to the first node through the writing transistor which has been placed into an on state based on a scanning signal from the scanning line; and

(c-2) placing the writing transistor into an off state based on the scanning signal from the scanning line to place the first node into a floating state and supplying current corresponding to a value of the potential difference between the first node and the second node to the light emitting element through the driving transistor in a state wherein the driving voltage is applied from the feeder line to the first one of the source/drain regions of the driving transistor.

Furthermore, the driving method for a display apparatus may further include, next to the step (c-2), the step of:

(c-3) setting the potential for the first node and the potential for the second node so that the potential difference between the first node and the second node may have a fixed value.

The driving method for a display apparatus may further include the step of:

controlling a value of a video signal to be applied to the data line based on a value of the current detected at the current detection step.

Meanwhile, the display apparatus according to the embodiments of the present invention may be configured such that a voltage which satisfies a condition that, when the current detection line and the second node are electrically connected to each other by the switching element placed in an on state, a potential difference between an anode electrode and a cathode electrode provided on the light emitting element does not exceed a threshold voltage of the light emitting element is applied to the current detection line.

The display apparatus may further include:

(7) a current detection section adapted to output a signal in response to a value of current flowing through the current detection line; and

(8) a signal controlling section configured to control a value of a video signal supplied from the signal outputting circuit;

the signal controlling section being controlled in response to the signal from the current detection section.

In the display apparatus and the driving method for a display apparatus according to the embodiments of the present invention including the preferred configurations described above (which are sometimes referred to generally as present invention), a light emitting element of the current driven type which emits light when current is supplied thereto can be used widely as the light emitting element which composes the display element. In particular, the light emitting element may be an organic electroluminescence light emitting element, an inorganic electroluminescence light emitting element, an LED (Light Emitting diode) light emitting element, a semiconductor laser light emitting element or the like. Such light emitting elements as just mentioned can be configured using well-known materials and methods. Among all of such light emitting elements, from a point of view that it is intended to configure a planar display apparatus of the color display type, the light emitting element is preferably formed as an organic electroluminescence light emitting element. The organic electroluminescence light emitting element may be any of the top emission type and the bottom emission type.

The conditions given by the various expressions herein are satisfied where the expressions are satisfied substantially as well as where the expressions are satisfied strictly in a mathematic sense. In other words, as regards satisfaction of each expression, the presence of various dispersions which occur in design or fabrication of the display element or the display apparatus is permissible.

In the embodiments of the present invention, the driving transistor is placed into an off state when the potential at the second node reaches a potential calculated by subtracting the threshold voltage of the driving transistor from the potential at the first node as a result of a threshold voltage cancellation process. On the other hand, if the potential at the second node does not reach the potential calculated by subtracting the threshold voltage of the driving transistor from the potential at the first node, then the potential difference between the first node and the second node is greater than the threshold voltage of the driving transistor, and consequently, the driving transistor is not placed into an off state. In the driving method of the embodiments of the present invention, it is not necessarily desired that the driving transistor be placed into an off state as a result of the threshold voltage cancellation process.

The step (c-1), that is, the writing process, may be carried out immediately or after a short time after the threshold voltage cancellation process is completed. Further, although the writing process is carried out preferably in a state wherein the driving voltage is applied to the first one of the source/drain regions of the driving transistors, it may be carried out otherwise in another state wherein the driving voltage is not applied to the first one of the source/drain regions of the driving transistor. In the former configuration, a mobility correction process of varying the potential at the second one of the source/drain regions of the driving transistor in response to a characteristic of the driving transistor is carried out in the writing process. It is to be noted that, although the step (c) is carried out preferably in a state wherein the driving voltage is applied to the first one of the source/drain regions of the driving transistor, it may be carried out otherwise in another state wherein the driving voltage is not applied to the first one of the source/drain regions of the driving transistor.

The display apparatus may have a monochromatic display configuration or a color display configuration. In particular, the display apparatus may have a color display configuration wherein one pixel is composed of a plurality of sub pixels, more particularly, one pixel is composed of three sub pixels including a red light emitting sub pixel, a green light emitting sub pixel and a blue light emitting sub pixel. Also it is possible to form a pixel from a set of sub pixels including such three sub pixels as described above and one or a plurality of additional sub pixels such as, for example, a set including an additional sub pixel for emitting white light for increasing the luminance, another set including additional sub pixels for emitting light of complementary colors for expanding the color reproduction range, a further set including an additional sub pixel for emitting light of yellow for expanding the color reproduction range or a still further set including additional sub pixels for emitting light of yellow and cyan for expanding the color reproduction range.

As the number of pixels for the display apparatus, several image display resolutions are available such as those of the VGA (640, 480), S-VGA (800, 600), XGA (1,024, 768), APRC (1,152, 900), S-XGA (1,280, 1,024), U-XGA (1,600, 1,200), HD-TV (1,920, 1,080), and Q-XGA (2,048, 1,536) as well as (1,920, 1,035), (720, 480) and (1,280, 960). However, the resolution of the display apparatus is not limited to any of the values given above.

In the display element and the display apparatus, various wiring lines such as the scanning line, data line, feeder line and current detection line and the light emitting element may have any well-known configuration or structure. For example, where the light emitting element is formed from an organic electroluminescence light emitting element, it can be formed from an anode electrode, a hole transport layer, a light emitting layer, an electron transport layer, a cathode electrode and so forth. Various circuits such as the power supply section, scanning circuit, signal outputting circuit and cathode voltage controlling circuit can be configured using well-known circuit elements and so forth.

The current detection section can be configured, for example, from a circuit which supplies current to be detected to a dc resistor and measures a voltage appearing across the dc resistor. Further, the current detection section may be configured from a suitable combination of the circuit described and another circuit for comparing a current value detected by the circuit described above with a reference value such as, for example, a value in an initial state or like circuit. The reference value may be determined in advance by actual measurement using a display apparatus and stored in advance in a storage section or the like. The configuration of the current detection section is not restricted specifically. Also the current detection section can be configured using well-known circuit elements and so forth.

The signal controlling section can be configured from a circuit which increases/decreases the value of a video signal to be applied to the data line in response to a signal from the current detection section. The signal controlling circuit may be configured, for example, from a circuit which controls the gain of an amplifier which composes the signal outputting circuit or from a multiplication circuit or the like for a digital value prior to D/A conversion. The configuration of the signal controlling section is not restricted specifically. Also the signal controlling section can be configured using well-known circuit elements and so forth.

The step of controlling the value of the video signal to be applied to the data line based on the value of the current detected at the current detection step can be carried out, for example, when the power supply to the display apparatus is made available. Or else, the period of time of use of the display apparatus may be integrated such that the step described is carried out every time the integrated period of time reaches a predetermined value. The frequency in this instance may be suitably set in accordance with the design of the display apparatus.

The transistors used to form the driving circuit may each be an n-channel thin film transistor (TFT). The transistors of the driving circuit may be of the enhancement type or of the depletion type. The n-channel transistor may have an LDD structure (Lightly Doped Drain structure) formed therein. Under certain circumstances, the LDD structure may be formed asymmetrically. For example, since high current flows to the driving transistor when the display element emits light, the LDD structure may be formed merely on the first one of the source/drain regions of the driving transistor which serves as the drain region when light is emitted. It is to be noted that a p-channel thin film transistor may be used instead.

The capacitive element which composes the driving circuit may be formed from a first electrode, a second electrode and a dielectric layer or insulating layer interposed between the electrodes. The transistors and the capacitive element described above which compose the driving circuit are formed in a particular plane, for example, on a substrate, and the light emitting element is disposed above the transistors and the capacitive element which compose the driving circuit, for example, with an interlayer insulating layer interposed therebetween. Meanwhile, the second one of the source/drain regions of the driving transistor is connected to the anode electrode provided on the light emitting element, for example, through a contact hole. It is to be noted that the transistors may be formed on a semiconductor substrate or the like.

While the present invention is described below in connection with preferred embodiments thereof with reference to the accompanying drawings, a general configuration of a display element and a display apparatus used in the embodiments is described first.

### 2. Outline of the Display Element and the Display Apparatus Used in the Embodiments

A display apparatus suitable for use in the embodiments includes a plurality of pixels. One pixel is composed of a plurality of sub pixels and, particularly in the embodiments described, composed of three sub pixels including a red light emitting sub pixel, a green light emitting sub pixel and a blue light emitting sub pixel. The light emitting element of the current driven type is formed from an organic electroluminescence light emitting element. Each sub pixel includes a display element 10 structured such that a driving circuit 11 and a light emitting element, that is, an light emitting element ELP, connected to the driving circuit 11, are laminated.

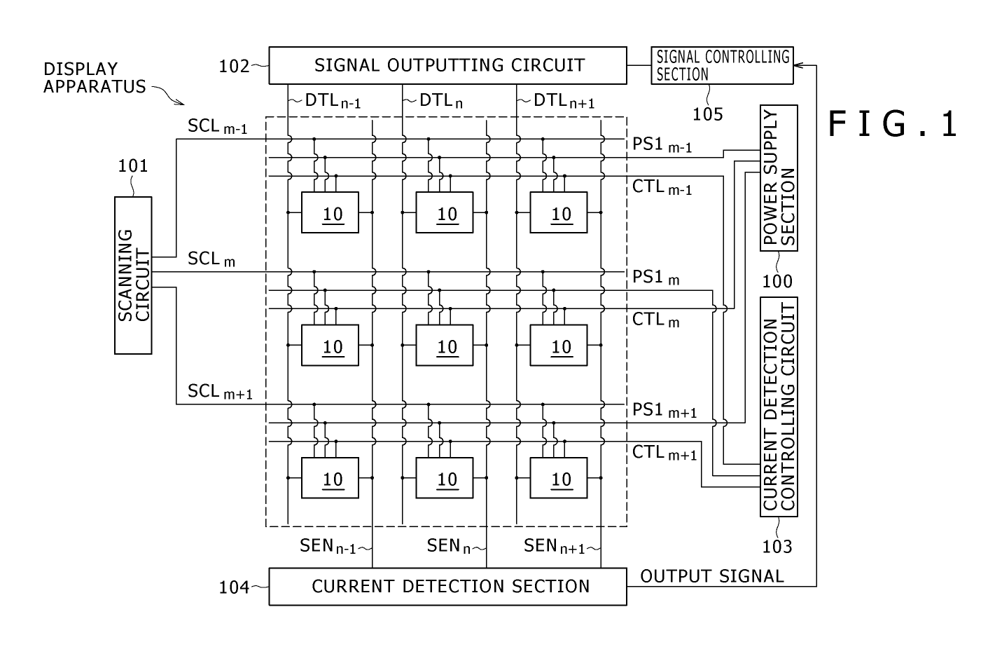

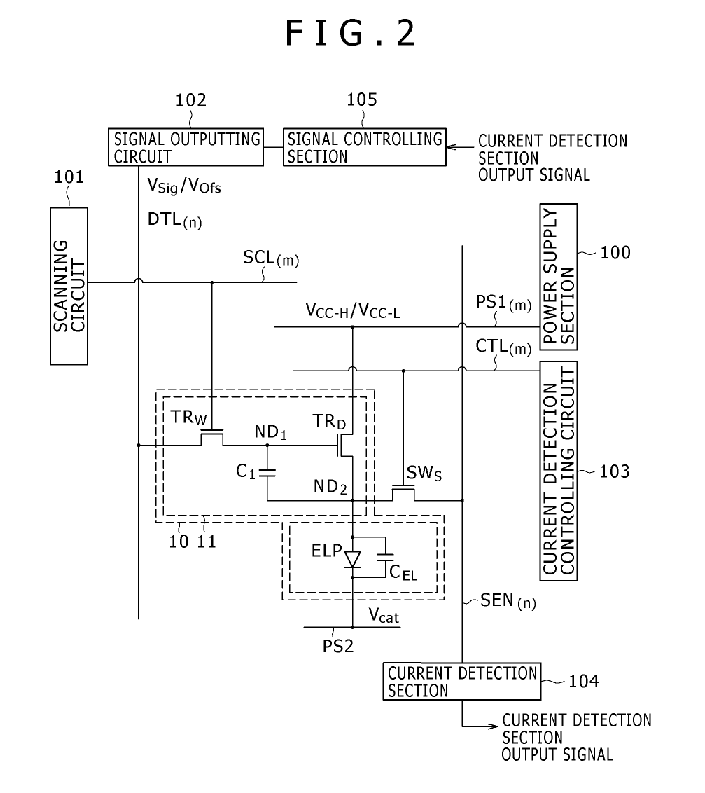

A concept diagram of the display apparatus used in the embodiments 1 to 3 is shown in FIG. 1. FIG. 2 shows an equivalent circuit diagram of the display element 10 which composes the display apparatus. The driving circuit 11 which composes the display element 10 is basically configured from two transistors/one capacitive element. The driving circuit is hereinafter referred to sometimes as 2Tr/1C driving circuit. It is to be noted that, in FIG. 1, a switching element SWₛ shown in FIG. 2 is omitted for the convenience of illustration.

Referring to FIG. 1, the display apparatus used in the embodiment 1 includes

(1) a scanning line SCL connected to a scanning circuit 101 and extending in a first direction;

(2) a data line DTL connected to a signal outputting circuit 102 and extending in a second direction;

(3) a display element 10 including a current-driven type light emitting element ELP and a driving circuit 11; and

(4) a feeder line PS1 connected to a power supply section 100 and extending in the first direction.

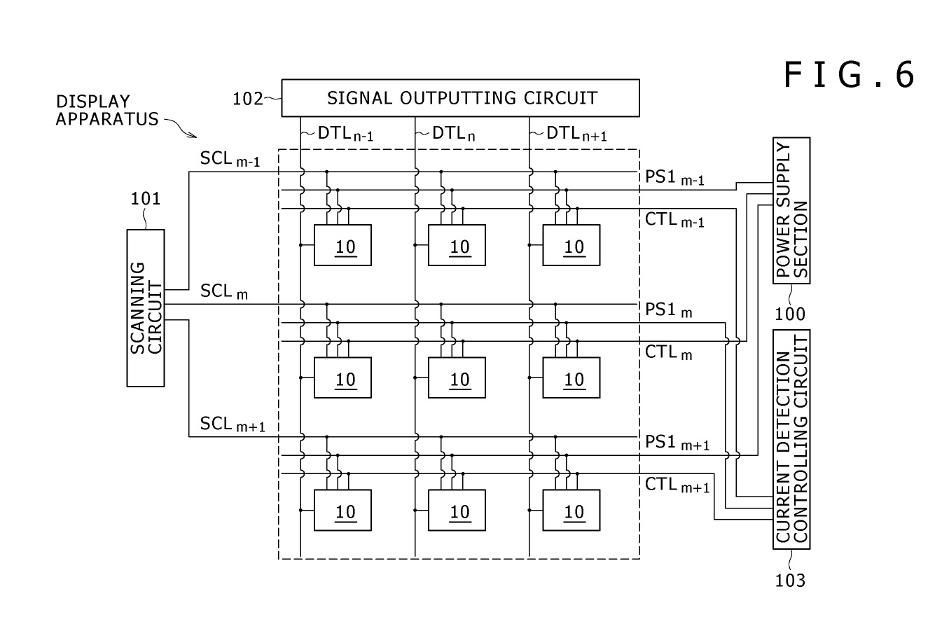

It is to be noted that, while, in FIG. 1 and FIG. 6 which is hereinafter referred to, 3×3 display elements 10 are shown, they are merely illustrative. It is to be noted that a second feeder line PS2 shown in FIG. 2 and so forth is omitted in FIGS. 1 and 6. The second feeder line PS2 is formed as a common feeder line.

The light emitting element ELP has a known configuration and structure including, for example, an anode electrode, a hole transport layer, a light emitting layer, an electron transport layer, a cathode electrode and so forth. The scanning circuit 101, signal outputting circuit 102, scanning line SCL, data line DTL and power supply section 100 may each have a well-known configuration and structure. Also a current detection controlling circuit 103 and a current detection line SEN which are hereinafter described may each have a well-known configuration and structure.

Minimum components of the driving circuit 11 are described. The driving circuit 11 includes at least a driving transistor TR_{D}, a writing transistor TR_{W} and a capacitive element C₁. The driving transistor TR_{D} is formed as an n-channel TFT having source/drain regions, a channel formation region and a gate electrode. Also the writing transistor TR_{W} is formed as an n-channel TFT having source/drain regions, a channel formation region and a gate electrode. It is to be noted that the writing transistor TR_{W} may alternatively be formed from a p-channel TFT.

Here, the driving transistor TR_{D} is configured such that

(A-1) a first one of source/drain regions is connected to the feeder line PS1; that

(A-2) a second one of the source/drain regions is connected to an end of the light emitting element ELP, in the embodiments, to the anode electrode of the light emitting element ELP, and also to a first one of electrodes of the capacitive element C₁ and forms a second node ND₂; and that

(A-3) the gate electrode is connected to the second one of the source/drain regions of the writing transistor TR_{W} and also to a second one of the electrodes of the capacitive element C₁ and forms a first node ND₁.

More particularly, in the display apparatus shown in FIG. 1, in the display element 10 in the mth row (where m=1, 2, . . . , M) and the nth column (where n=1, 2, . . . , N), the first one of the source/drain regions of the driving transistor TR_{D} is connected to the mth feeder line PS1ₘ.

Meanwhile, the writing transistor TR_{W} is configured such that

(B-1) a first one of source/drain regions is connected to the data line DTL; and that

(B-2) the gate electrode is connected to the scanning line SCL.

More particularly, in the display apparatus shown in FIG. 1, in the display element 10 in the mth row and the nth column, the first one of the source/drain regions of the writing transistor TR_{W} is connected to the nth data line DTLₙ. The gate electrode of the writing transistor TR_{W} is connected to the mth scanning line SCLₘ.

The second end of the light emitting element ELP, in the embodiments, the cathode electrode of the light emitting element ELP, is connected to the second feeder line PS2. A voltage V_{cat} hereinafter described, which is, for example, 0 volt, is applied to the second feeder line PS2.

The display apparatus further includes:

(5) a current detection line SEN extending in the second direction; and

(6) a switching element SWₛ disposed between the second node ND₂ and the current detection line SEN.

In the embodiments, the switching element SWₛ is formed from an n-channel TFT. However, the switching element SWₛ is not limited to this.

In the display element 10 in the mth row and the nth column, the second node ND₂ and the nth current detection line SENₙ are connected to each other through the switching element SWₛ. The current detection line SEN is connected to a current detection section 104. A voltage V_{SEN} which satisfies a condition that, when the current detection line SEN and the second node ND₂ are electrically connected to each other by the switching element SWₛ placed in an on state, a potential difference between the anode electrode and the cathode electrode provided on the light emitting element ELP does not exceed a threshold voltage V_{th-EL} of the light emitting element ELP is applied to the current detection line SEN. The voltage V_{SEN} is hereinafter described.

The display apparatus includes a control line CTL connected to the current detection controlling circuit 103 and extending in the first direction. In the display element 10 in the mth and the nth column, the gate electrode of the switching element SWₛ is connected to the mth control line CTLₘ. The on/off operations of the switching element SWₛ are controlled based on a signal from the mth control line CTLₘ.

The display apparatus further includes:

(7) a current detection section 104 adapted to output a signal in response to a value of current flowing through the current detection line SEN; and

(8) a signal controlling section 105 for controlling a value of a video signal V_{Sig} supplied from the signal outputting circuit 102; and

the signal controlling section 105 is controlled in response to the signal from the current detection section 104.

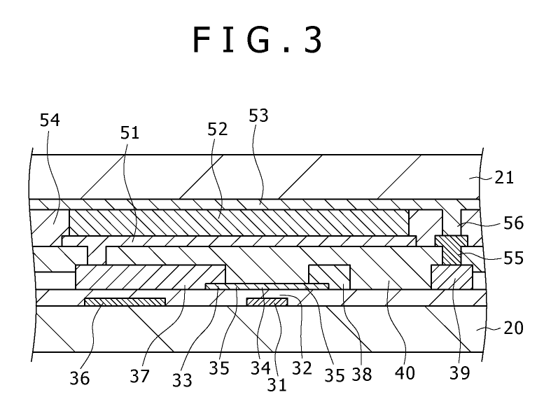

A schematic sectional view of part of the display apparatus is shown in FIG. 3. Referring to FIG. 3, the transistors TR_{D} and TR_{W} and the capacitive element C₁ which compose the driving circuit 11 are formed on a substrate 20. Also the switching element SWₛ is formed on the substrate 20 similarly. The light emitting element ELP is formed above the transistors TR_{D} and TR_{W} and the capacitive element C₁ of the driving circuit 11, for example, with an interlayer insulating layer 40 interposed therebetween. Meanwhile, the second one of the source/drain regions of the driving transistor TR_{D} is connected to the anode electrode provided on the light emitting element ELP through a contact hole. It is to be noted that, in FIG. 3, only the driving transistor TR_{D} is shown while the other transistors are hidden and not shown.

More particularly, the driving transistor TR_{D} includes a gate electrode 31, a gate insulating layer 32, source/drain regions 35 provided in a semiconductor layer 33, and a channel formation region 34 formed from a portion of the semiconductor layer 33 between the source/drain regions 35. Meanwhile, the capacitive element C₁ includes a second electrode 36, a dielectric layer formed from an extension of the gate insulating layer 32 and a first electrode 37 which corresponds to the second node ND₂. The gate electrode 31, part of the gate insulating layer 32 and the second electrode 36 which forms the capacitive element C₁ are formed on the substrate 20. The first one of the source/drain regions 35 of the driving transistor TR_{D} is connected to a wiring line 38, and the second one of the source/drain regions 35 of the driving transistor TR_{D} is connected to the first electrode 37. The driving transistor TR_{D}, capacitive element C₁ and so forth are covered with an interlayer insulating layer 40, and a light emitting element ELP formed from an anode electrode 51, a hole transport layer, a light emitting layer, an electron transport layer and a cathode electrode 53 is provided on the interlayer insulating layer 40. It is to be noted that, in FIG. 3, the hole transport layer, light emitting layer and electron transport layer are represented by a single layer 52. A second interlayer insulating layer 54 is provided on a portion of the interlayer insulating layer 40 on which the light emitting element ELP is not provided, and a transparent substrate 21 is disposed on the second interlayer insulating layer 54 and the cathode electrode 53 such that light emitted from the light emitting layer is emitted to the outside through the substrate 21. It is to be noted that the first electrode 37, that is, the second node ND₂, and the anode electrode 51 are connected to each other through a contact hole formed in the interlayer insulating layer 40. The cathode electrode 53 is connected to a wiring line 39 provided on the extension of the gate insulating layer 32 through contact holes 56 and 55 provided in the second interlayer insulating layer 54 and the interlayer insulating layer 40.

A fabrication method of the display apparatus shown in FIG. 3 and so forth is described. First, the wiring lines such as the scanning line SCL, electrodes which compose the capacitive element C₁, transistors formed from semiconductor layers, interlayer insulating layers, contact holes and so forth are suitably formed on and in the substrate 20 by well-known methods. Then, film formation and patterning are carried out by well-known methods to form the light emitting elements ELP arrayed in a matrix. Then, the substrate 20 and the substrate 21 after the steps described above are disposed in an opposing relationship to each other, and the substrate 20 and the substrate 21 are sealed along an outer periphery thereof. Thereafter, connection to external circuits is carried out to obtain the display apparatus.

The display apparatus in each embodiment is a display apparatus for color display which includes a plurality of display elements 10, for example, N×M=1,920×480 display elements 10. Each of the display elements 10 configures a sub pixel, and one pixel is formed from a group including a plurality of sub pixels. Such sub pixels are arrayed in a two-dimensional matrix in a first direction and a second direction different from the first direction. One pixel is composed of three different sub pixels including a red light emitting sub pixel which emits red light, a green light emitting sub pixel which emits green light and a blue light emitting sub pixel which emits blue light.

The display apparatus includes N/3×M pixels arrayed in a two-dimensional matrix. The display elements 10 which form the pixels are scanned line-sequentially at a display frame rate FR (number of times/second). In particular, those display elements 10 which form N/3 pixels, and hence N sub pixels, arrayed in the mth row are driven at a time. In other words, in the display elements 10 which form one row, the light emitting/no-light emitting timings are controlled in a unit of the row to which the display elements 10 belong. It is to be noted that the process of writing a video signal into pixels which form one row may be a process of writing video signals simultaneously into all pixels (such process is hereinafter referred to sometimes as simultaneous writing process) or another process of writing video signals successively into the pixels (such process is hereinafter referred to sometimes as successive writing process). Which one of the writing processes should be used may be suitably selected in accordance with the configuration of the display apparatus.

As described above, the display elements 10 in the first to Mth rows are scanned line-sequentially. For the convenience of description, the period applied to scan the display elements 10 in each row is represented as horizontal scanning period. In the embodiments hereinafter described, each horizontal scanning period includes a period hereinafter referred to as initialization period within which a first node initialization voltage is applied from the signal outputting circuit 102 to the data line DTL and a subsequent period hereinafter referred to as video signal period within which a video signal, which is a video signal V_{Sig} hereinafter described, is applied from the signal outputting circuit 102 to the data line DTL.

While driving and operation regarding the display element 10 positioned in the mth row and the nth column in principle are described below, the display element 10 is hereinafter referred to as (n, m)th display element 10 or (n, m)th sub pixel. Thus, before a horizontal scanning period of the display elements 10 arrayed in the mth row, that is, the mth horizontal scanning period, comes to an end, various processes including a threshold voltage cancellation process, a writing process and a mobility correction process hereinafter described are carried out. It is to be noted that the writing process or the mobility correction process is carried out within the mth horizontal scanning period. On the other hand, the threshold voltage cancellation process and a pre-process for the threshold voltage cancellation process can be carried out preceding to the mth horizontal scanning period.

Then, after all of the various processes described above are completed, the light emitting element ELP which composes each of the display elements 10 arrayed in the mth row is driven to emit light. It is to be noted that, after all of the processes described above are completed, the light emitting element ELP may be driven to emit light immediately or after lapse of a predetermined interval of time such as, for example, an interval of time corresponding to a number of horizontal scanning periods equal to a predetermined number of rows. This predetermined interval of time may be set suitably in accordance with specifications of the display apparatus, the configuration of the driving circuit and so forth. It is to be noted that, in the following description, the light emitting element ELP is driven to emit light immediately after the various processes are completed for the convenience of description. Then, the light emitting state of the light emitting element ELP which forms each of the display elements 10 arrayed in the mth row is maintained till a point of time immediately prior to starting of a horizontal scanning period for the display elements 10 arrayed in the (m+m′)th row. Here, “m′” is determined based on the design specifications of the display apparatus. In particular, emission of light from the light emitting element ELP which forms each of the display elements 10 arrayed in the mth row in a certain display frame is continued till the (m+m′−1)th horizontal scanning period. On the other hand, the light emitting element ELP which forms each of the display elements 10 arrayed in the mth row maintains a no-light emitting state in principle after a start timing of the (m+m′)th horizontal period until the writing process or the mobility correction process is completed within the mth horizontal scanning period in the succeeding display frame. By providing the period within which the no-light emitting state described above is maintained (such period may be hereinafter referred to simply as no-light emitting period), after-image blurring caused by active matrix driving is reduced, and improved moving picture quality can be achieved. It is to be noted, however, that the light emitting state/no-light emitting state of each sub pixel or display element 10 are not limited to those described above. Further, the time length of the horizontal scanning period is less than 1/FR×1/M second. If the value of m+m′ exceeds M, then the excessive part of the horizontal scanning period is processed in a next display frame.

In regard to the two source/drain regions which one transistor has, the term “first one of the source/drain regions” is sometimes used so as to signify the source/drain region connected to the power supply side. Further, that a transistor is in an on state signifies a state wherein a channel is formed between the source and drain regions. It does not matter whether or not current is flowing from the first one to the second one of the source/drain regions of the transistor. On the other hand, that a transistor is in an off state signifies a state wherein no channel is formed between the source and drain regions. Further, that one of the source/drain regions of a certain transistor is connected to one of the source/drain regions of another transistor includes a mode wherein the source or drain region of the former transistor and the source or drain region of the latter transistor occupy the same region. Further, the source/drain regions can be formed from a layer formed from a metal, an alloy, conductive particles, a laminate structure of them or an organic material, which is conductive high molecules as well as from a conductive substance such as polycrystalline silicon or amorphous silicon which contains some impurity. Further, in timing charts referred to in the following description, the length of the axis of abscissa indicating various periods, that is, the time length, is a schematic representation and does not indicate ratios in time length between the periods. This similarly applies also to the axis of ordinate. Also the waveforms in the timing charts are schematic representations.

In the following, the present invention is described in connection with the preferred embodiments thereof.

### 3. Embodiment 1

The embodiment 1 relates to a display apparatus of the embodiments of the present invention and a driving method for a display apparatus of the embodiments of the present invention.

Referring to FIG. 2, a driving circuit 11 which composes a display element 10 is formed from two transistors including a writing transistor TR_{W} and a driving transistor TR_{D} and a single capacitive element C₁ and therefore is formed as a 2Tr/1C driving circuit. In the following, a configuration of the (n, m)th display element 10 is described.

### Driving Transistor TR_{D}

A first one of the source/drain regions of the driving transistor TR_{D} is connected to an mth feeder line PS1ₘ. To the first one of the source/drain regions of the driving transistor TR_{D}, a predetermined voltage is applied from the feeder line PS1ₘ based on operation of the power supply section 100. In particular, a driving voltage V_{CC-H} and a voltage V_{CC-L} hereinafter described are applied from the power supply section 100. Meanwhile, the driving transistor TR_{D} is connected at the other one, that is, at a second one, of the source/drain regions, thereof to

[1] the anode electrode of the light emitting element ELP and

[2] a first one of the electrodes of the capacitive element C₁

and forms a second node ND₂. Meanwhile, the driving transistor TR_{D} is connected at the gate thereof to

[1] the second one of the source/drain regions of the writing transistor TR_{W} and

[2] a second one of the electrodes of the capacitive element C₁

and forms a first node ND₁.

Here, the driving transistor TR_{D} is driven, in a light emitting state of the display element 10, to supply drain current I_{ds} in accordance with an expression (1) given below. In the light emitting state of the display element 10, the first one of the source/drain regions of the driving transistor TR_{D} acts as a drain region while the second one of the source/drain regions of the driving transistor TR_{D} acts as a source region. For the convenience of description, in the following description, the first one of the source/drain regions of the driving transistor TR_{D} is sometimes referred to simply as drain region, and the second one of the source/drain regions of the driving transistor TR_{D} is sometimes referred to simply as source region. It is to be noted that the following parameters are used:

μ: effective mobility
L: channel length
W: channel width
V_{gs}: potential difference between the gate electrode and the source region
Vₜₕ: threshold voltage
C_{OX}: relative dielectric constant of the gate insulating layer×dielectric constant of the vacuum/thickness of the gate insulating film

k=(1/2)·(W/L)·C_{OX}

I_{ds}=k·μ·(V_{gs}−Vₜₕ)² (1)

When the drain current I_{ds} flows through the light emitting element ELP of the display element 10, the light emitting element ELP of the display element 10 emits light. Further, the light emitting state, that is, the luminance, of the light emitting element ELP of the display element 10 is controlled by the magnitude of the value of the drain current I_{ds}.

### Writing Transistor TR_{W}

The second one of the source/drain regions of the writing transistor TR_{W} is connected to the gate electrode of the driving transistor TR_{D} as described hereinabove. Meanwhile, the first one of the source/drain regions of the writing transistor TR_{W} is connected to an nth data line DTLₙ. To the first one of the source/drain regions of the writing transistor TR_{W}, a predetermined voltage is applied from the nth data line DTLₙ based on operation of a signal outputting circuit 102. In particular, a video signal (driving signal or luminance signal) V_{Sig} for controlling the luminance of the light emitting element ELP and a first node initializing voltage V_{Ofs} hereinafter described are supplied from the signal outputting circuit 102. The on/off operation of the writing transistor TR_{W} is controlled by a scanning signal from an mth scanning line SCLₘ connected to the gate electrode of the writing transistor TR_{W}, particularly by a scanning signal from a scanning circuit 101.

### Light Emitting Section ELP

The anode electrode of the light emitting element ELP is connected to the source region of the driving transistor TR_{D} as described above. Meanwhile, the cathode electrode of the light emitting element ELP is connected to the second feeder line PS2. The parasitic capacitance of the light emitting element ELP is represented by reference character C_{EL}. Meanwhile, the threshold voltage desired for emission of light of the light emitting element ELP is represented by V_{th-EL}. In particular, if a voltage higher than the threshold voltage V_{th-EL} is applied between the anode electrode and the cathode electrode of the light emitting element ELP, then the light emitting element ELP emits light.

Now, the display apparatus and the driving method for the display apparatus according to the embodiment 1 are described.

While the following description is given under the assumption that the voltages or potentials have the values specified below, the values are merely for illustration and the voltages or potentials are not limited to the specific values.

V_{Sig}: video signal for controlling the luminance of the light emitting element ELP
1 volt (black display) to 8 volt (white display)

(It is to be noted that the values are, for example, initial values and may possibly assume values higher than 8 volt)

V_{CC-H}: driving voltage for supplying current to the light emitting element ELP
20 volt
   V_{CC-L}: second node initialization voltage
−10 volt
   V_{Ofs}: first node initialization voltage for initializing the potential of the gate electrode of the driving transistor TR_{D}, that is, the potential at the first node ND₁
0 volt
   Vₜₕ: threshold voltage of the driving transistor TR_{D}
3 volt
   V_{Cat}: voltage applied to the cathode electrode of the light emitting element ELP
0 volt
   V_{SEN}: potential of the current detection line
−15 volt
   V_{th-EL}: threshold voltage of the light emitting element ELP
3 volt

The driving method for the display element and the display apparatus according to the embodiment 1 (the method is hereinafter referred to simply as driving method) includes the steps of:

(a) carrying out a pre-process for initializing the potential of the first node ND₁ and the potential of the second node ND₂ so that the potential difference between the first node ND₁ and the second node ND₂ exceeds the threshold voltage Vₜₕ of the driving transistor TR_{D} and the potential difference between the second node ND₂ and the second end of the light emission section ELP does not exceed the threshold voltage V_{th-EL} of the light emission section ELP; and

(b) carrying out a threshold voltage cancellation process for varying the potential at the second node ND₂ toward a potential calculated by subtracting the threshold voltage Vₜₕ of the driving transistor TR_{D} from the potential at the first node ND₁ in a state wherein the potential at the first node ND₁ is maintained.

That the two steps (a) and (b) specified above are included similarly applies also to the other embodiments hereinafter described. It is to be noted that, while, in the embodiments described, the threshold voltage cancellation process is carried out by a plural number of times over a plurality of scanning periods, it may not be carried out by a plural number of times.

In the embodiment 1, after the two steps (a) and (b) are carried out,

(c) a step of applying a reference voltage to the first node ND₁

is carried out, whereafter the current detection step described hereinabove is carried out. It is to be noted that, in the embodiment 1, the step (c) is carried out in a state wherein the driving voltage V_{CC-H} is applied to the first one of the source/drain regions of the driving transistor TR_{D} through the feeder line PS1ₘ.

It is to be noted that, in the embodiment 2 hereinafter described, steps (c-1) and (c-2) hereinafter described are carried out in place of the step (c). Further, in the embodiment 3 hereinafter described, a step (c-3) hereinafter described is carried out next to the step (c-2). The steps mentioned are hereinafter described.

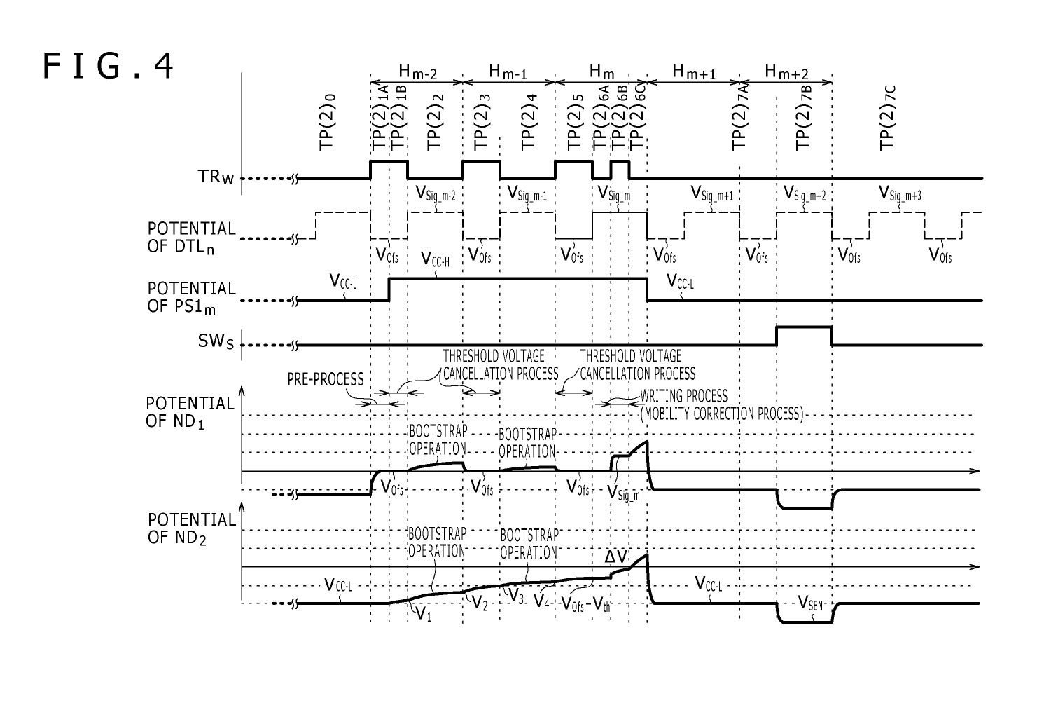

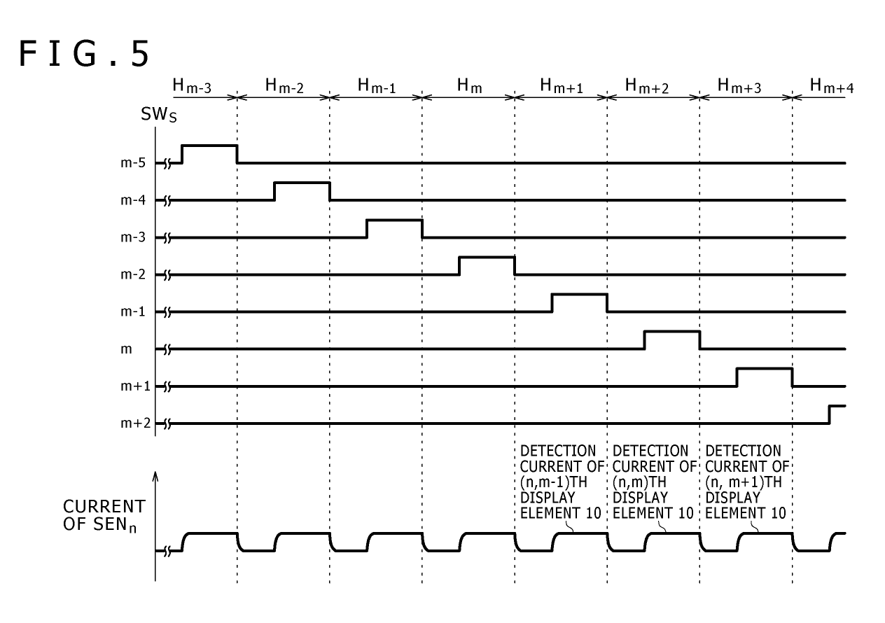

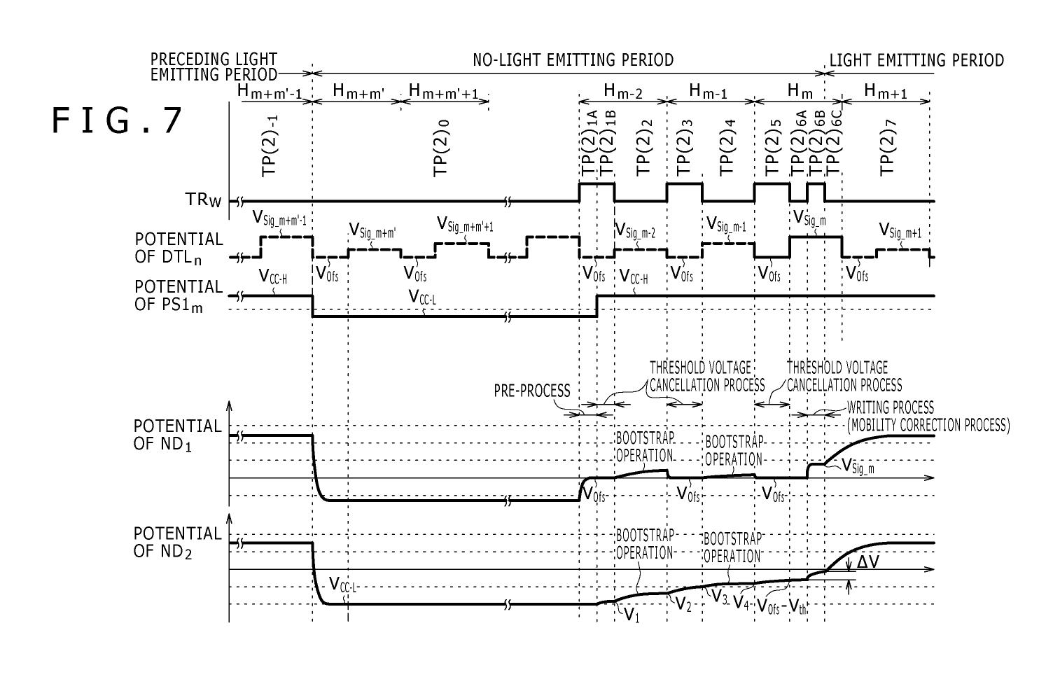

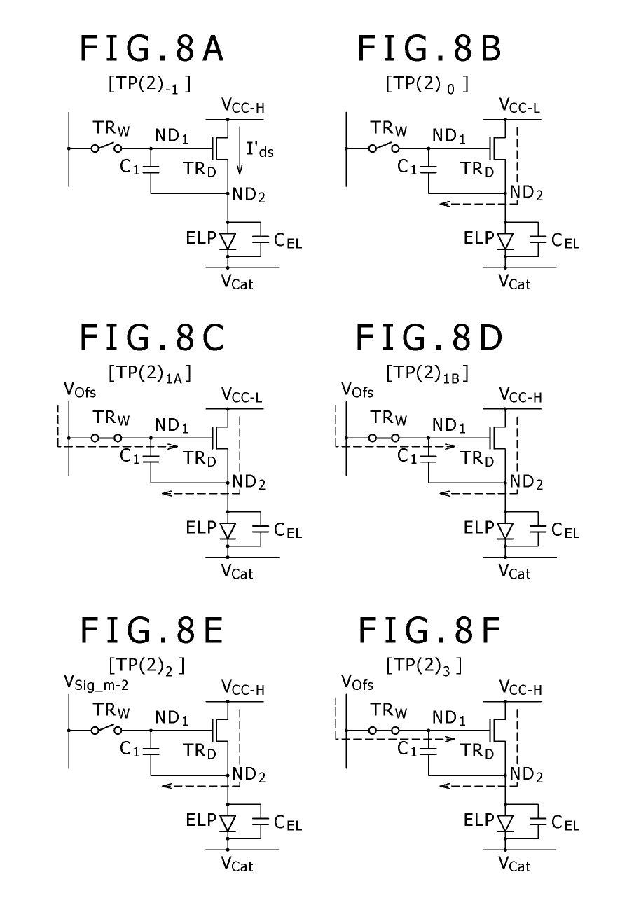

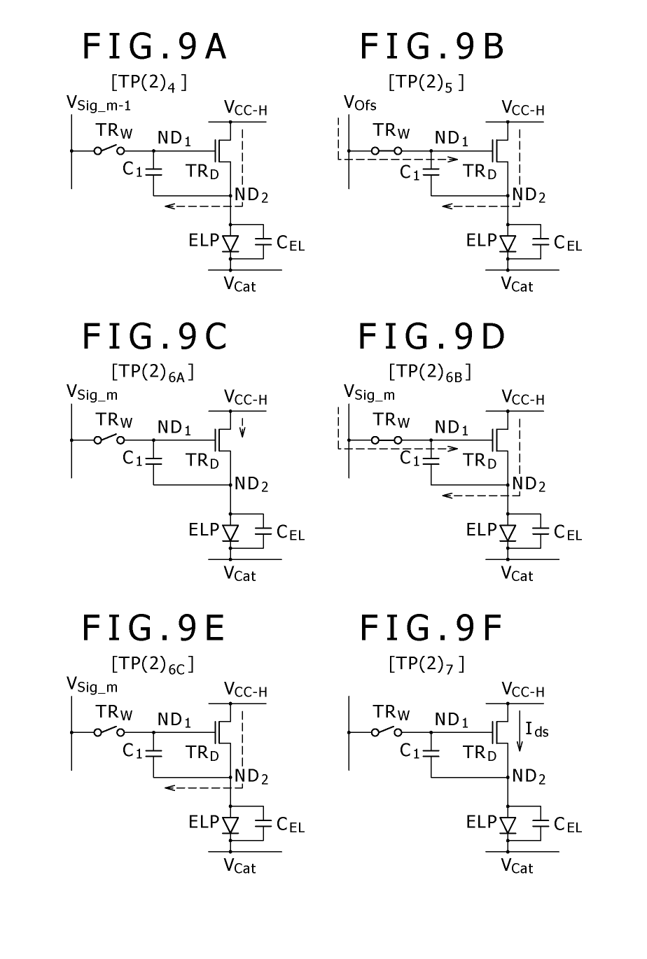

First, in order to facilitate understandings of the present invention, a driving method which uses a display apparatus according to a reference example which eliminates a current detection line SENₙ, a switching element SWₛ, a control line CTLₘ, a current detection controlling circuit 103, a current detection section 104 and a signal controlling section 105 is described as a driving method of a reference example. A timing chart of driving of the display element 10 according to the embodiment 1 is schematically shown in FIG. 4, and a timing chart of detection current according to the embodiment 1 is shown in FIG. 5. A circuit diagram of a display apparatus according to the reference example is shown in FIG. 6, and a timing chart of driving of the display element 10 according to the reference example is shown in FIG. 7. Further, on/off stages and so forth of transistors of the display element 10 in operation of the reference example are schematically illustrated in FIGS. 8A to 8F and 9A to 9F.

The driving method of the reference example is described with reference to FIGS. 7, 8A to 8F and 9A to 9F.

### Period TP(2)₋₁ (Refer to FIGS. 7 and 8A)

Within this period TP(2)₋₁, operation for a preceding display frame is carried out, and the (n, m)th display element 10 is in a light emitting state after completion of various processes in the preceding operation cycle. In particular, drain current I′_{ds} based on an expression (5′) hereinafter given flows through the light emitting element ELP of the display element 10 which forms the (n, m)th sub pixel, and the luminance of the display element 10 which forms the (n, m)th sub pixel exhibits a value corresponding to the drain current I′_{ds}. Here, the writing transistor TR_{W} is in an off state and the driving transistor TR_{D} is in an on state. The light emitting state of the (n, m)th display element 10 continues till a point of time immediately prior to starting of a horizontal scanning period of the display elements 10 disposed in the (m+m′)th row.

It is to be noted that, for each horizontal scanning period, the first node initializing voltage V_{Ofs} and the video signal V_{Sig} are applied to the data line DTLₙ. However, since the writing transistor TR_{W} is in an off state, even if the potential or voltage of the data line DTLₙ varies within the period TP(2)₋₁, the potentials at the first node ND₁ and the second node ND₂ do not vary. Actually, some potential difference may possibly be caused by electrostatic coupling of parasitic capacitance and so forth. However, the potential difference can normally be ignored. This similarly applies also to the period TP(2)₀.

The periods from the period TP(2)₀ to the period TP(2)_{6A} are an operation period from a point of time after the light emitting state after completion of the various processes in the preceding operation cycle to a point of time immediately before a next writing process is carried out. Then, within the period TP(2)₀ to the period TP(2)_{6B}, the (n, m)th display element 10 remains in a no-light emitting period in principle. As seen in FIG. 7, the period TP(2)_{6B} and the period TP(2)_{6C} as well as the period TP(2)₅ to the period TP(2)_{6A} are included in the mth horizontal scanning period Hₘ.

In the reference example and the embodiments hereinafter described, the step (b) described hereinabove, that is, the threshold voltage cancellation process, is carried out over a plurality of scanning periods, more particularly over the (m−2)th horizontal scanning period Hₘ₋₂ to the mth horizontal scanning period Hₘ, the period within which the threshold voltage cancellation process is to be carried out is not limited to this.

For the convenience of description, it is assumed that the start timing of the period TP(2)_{1A} coincides with the start timing of an initialization period within the (m−2)th horizontal scanning period that is, within a period within which the potential of the data line DTLₙ is the first node initializing voltage V_{Ofs}. This similarly applies also to the other horizontal scanning periods. Similarly, the end timing of the period TP(2)_{1B} coincides with the end timing of the initialization period within the (m−2)th horizontal scanning period Hₘ₋₂. Further, the start timing of the period TP(2)₂ coincides with the start timing of a video signal period within the (m−2)th horizontal scanning period that is, a period within which the potential of the data line DTLₙ is the video signal V_{Sig} in FIG. 7. This similarly applies also to the other horizontal scanning periods.

In the following, the periods from the period TP(2)₀ to a period TP(2)₇ are described. It is to be noted that the start timing of the period TP(2)_{1B} and the length of the periods from the period TP(2)_{6A} to the period TP(2)_{6C} may be set suitably in accordance with the design of the display element and the display apparatus.

### Period TP(2)₀ (Refer to FIGS. 7 and 8B)

Operation within this period TP(2)₀ is operation, for example, from the preceding display frame to the current display frame. In other words, the period TP(2)₀ is a period from the start timing of the (m+m′)th horizontal scanning period H_{m+m′} in the preceding display frame to the (m−3)th horizontal scanning period in the current display frame. Then, within the period TP(2)₀, the (n, m)th display element 10 is in a no-light emitting period in principle. At the start timing of the period TP(2)₀, the voltage to be supplied from the power supply section 100 to the feeder line PS1ₘ is changed over from the driving voltage V_{CC-H} to the second node initializing voltage V_{CC-L}. As a result, the potential at the second node ND₂ drops to the second node initializing voltage V_{CC-L}, and a reverse direction voltage is applied between the anode electrode and the cathode electrode of the light emitting element ELP. Consequently, the light emitting element ELP is placed into a no-light emitting state. Also the potential at the first node ND₁ in a floating state, that is, at the gate electrode of the driving transistor TR_{D}, drops in such a manner as to follow up the potential drop at the second node ND₂.

### Period TP(2)_{1A} (Refer to FIGS. 7 and 8C)

Then, the (m−2)th horizontal scanning period Hₘ₋₂ in the current display frame is started. Within this period TP(2)_{1A}, the step (a) described hereinabove, that is, the pre-process, is carried out.

As described hereinabove, within each horizontal scanning period, the first node initializing voltage V_{Ofs} is applied from the signal outputting circuit 102 to the data line DTLₙ, and then the video signal V_{Sig} is applied in place of the first node initializing voltage V_{Ofs}. More particularly, within the (m−2)th horizontal scanning period Hₘ₋₂ of the current display frame, the first node initializing voltage V_{Ofs} is applied to the data line DTLₙ, and then a video signal V_{Sig}_{_{—}}ₘ₋₂ corresponding to the (n, m−2)th sub pixel is applied in place of the first node initializing voltage V_{Ofs}. Though not shown in FIG. 7, also within other horizontal scanning periods than the horizontal scanning periods Hₘ₋₂, Hₘ₋₁, Hₘ, Hₘ₊₁, H_{m+m′-1}, H_{m+m′} and H_{m+m′+1}, the first node initializing voltage V_{Ofs} and the video signal V_{Sig} are applied to the data line DTLₙ.

In particular, at the start timing of the period TP(2)_{1A}, the mth scanning line SCLₘ is placed into a high level state to place the writing transistor TR_{W} into an on state. The voltage applied from the signal outputting circuit 102 to the data line DTLₙ is the first node initializing voltage V_{Ofs} (initialization period). As a result, the potential at the first node ND₁ becomes the first node initializing voltage V_{Ofs}, which is 0 volt. Since the second node initializing voltage V_{CC-L} is applied from the feeder line PS1ₘ to the second node ND₂ through operation of the power supply section 100, the potential at the second node ND₂ maintains the second node initializing voltage V_{CC-L}, which is −10 volt.

Since the potential difference between the first node ND₁ and the second node ND₂ is 10 volt and the threshold voltage Vₜₕ of the driving transistor TR_{D} is 3 volt, the driving transistor TR_{D} is in an on state. It is to be noted that the potential difference between the second node ND₂ and the cathode electrode of the light emitting element ELP is −10 volt, which does not exceed the threshold voltage V_{th-EL} of the light emitting element ELP. The pre-process of initializing the potential at the first node ND₁ and the potential at the second node ND₂ is completed thereby.

The pre-process may be configured otherwise such that the writing transistor TR_{W} is placed into an on state after the voltage to be applied to the data line DTLₙ changes over to the first node initializing voltage V_{Ofs}. Or, the pre-process may alternatively be configured such that writing transistor TR_{W} is placed into an on state in response to a signal from the scanning line prior to the start timing of the horizontal scanning period within which the pre-process is carried out. According to the latter configuration, immediately after the first node initializing voltage V_{Ofs} is applied to the data line DTLₙ, the potential at the first node ND₁ is initialized. In the former configuration wherein the writing transistor TR_{W} is placed into an on state after the voltage to be applied to the data line DTLₙ changes over to the first node initializing voltage V_{Ofs}, the time has to be distributed to the pre-process including also the period of time within which the changeover is waited. On the other hand, in the latter configuration, the time for waiting the changeover is unnecessary and the pre-process can be carried out in a shorter period of time.

Then, the step (b) described hereinabove, that is, the threshold voltage cancellation process, is carried out over the period TP(2)_{1B} to the period TP(2)₅. In particular, within the period TP(2)_{1B}, the first time threshold voltage cancellation process is carried out, and within the period TP(2)₃, the second time threshold voltage cancellation process is carried out, whereafter, within the period TP(2)₅, the third time threshold voltage cancellation process is carried out.

### Period TP(2)_{1B} (Refer to FIGS. 7 and 8D)

Within the period TP(2)_{1B}, the voltage to be supplied from the power supply section 100 to the feeder line PS1ₘ is changed over from the second node initializing voltage V_{CC-L} to the driving voltage V_{CC-H} while the on state of the writing transistor TR_{W} is maintained. As a result, although the potential at the first node ND₁ does not vary but maintains V_{Ofs}=0 volt, the potential at the second node ND₂ changes to a potential calculated by subtracting the threshold voltage Vₜₕ of the driving transistor TR_{D} from the potential at the first node ND₁. In other words, the potential at the second node ND₂ rises.

If this period TP(2)_{1B} is sufficiently long, then the potential difference between the gate electrode and the second one of the source/drain regions of the driving transistor TR_{D} reaches the threshold voltage Vₜₕ and the driving transistor TR_{D} is placed into an off state. In particular, the potential at the second node ND₂ approaches the difference V_{Ofs}−Vₜₕ. However, in the example shown in FIG. 7, the length of the period TP(2)_{1B} is insufficient to change the potential at the second node ND₂ sufficiently, and at the end timing of the period TP(2)_{1B}, the potential at the second node ND₂ reaches a certain potential V₁ which satisfies a relationship of V_{CC-L}<V₁<V_{Ofs}−Vₜₕ.

### Period TP(2)₂ (Refer to FIGS. 7 and 8E)

At the start timing of the period TP(2)₂, the voltage of the data line DTLₙ is changed over from the first node initializing voltage V_{Ofs} to the video signal V_{Sig}_{_{—}}ₘ₋₂. At the start timing of the period TP(2)₂, the writing transistor TR_{W} is placed into an off state with a signal from the mth scanning line SCLₘ so that the video signal V_{Sig}_{_{—}}ₘ₋₂ may not be applied to the first node ND₁. As a result, the first node ND₁ enters a floating state.

Since the driving voltage V_{CC-H} is applied from the power supply section 100 to the first one of the source/drain regions of the driving transistor TR_{D}, the potential at the second node ND₂ rises from the potential V₁ to another certain potential V₂. Meanwhile, since the gate electrode of the driving transistor TR_{D} is in a floating state and the capacitive element C₁ exists, a bootstrap operation occurs with the gate electrode of the driving transistor TR_{D}. Accordingly, the potential at the first node ND₁ rises following up the potential variation of the second node ND₂.

### Period TP(2)₃ (Refer to FIGS. 7 and 8F)

At the start timing of the period TP(2)₃, the voltage of the data line DTLₙ changes over from the video signal V_{Sig}_{_{—}}ₘ₋₂ to the first node initializing voltage V_{Ofs}. At the start timing of the period TP(2)₃, the writing transistor TR_{W} is placed into an on state with a signal from the mth scanning line SCLₘ. As a result, the potential at the first node ND₁ becomes equal to the first node initializing voltage V_{Ofs}. The driving voltage V_{CC-H} is applied from the power supply section 100 to the first one of the source/drain regions of the driving transistor TR_{D}. As a result, the potential at the second node ND₂ changes toward a potential calculated by subtracting the threshold voltage Vₜₕ of the driving transistor TR_{D} from the potential at the first node ND₁. In other words, the potential at the second node ND₂ rises from the potential V₂ to another certain potential V₃.

### Period TP(2)₄ (Refer to FIGS. 7 and 9A)

At the start timing of the period TP(2)₄, the voltage of the data line DTLₙ changes over from the first node initializing voltage V_{Ofs} to the video signal V_{Sig}_{_{—}}ₘ₋₁. At the start timing of the period TP(2)₄, the writing transistor TR_{W} is placed into an off state with a signal from the mth scanning line SCLₘ so that the video signal V_{Sig}_{_{—}}ₘ₋₁ may not be applied to the first node ND₁. As a result, the first node ND₁ enters a floating state.

Since the driving voltage V_{CC-H} is applied from the power supply section 100 to the first one of the source/drain regions of the driving transistor TR_{D}, the potential at the second node ND₂ rises from the potential V₃ to another certain potential V₄. On the other hand, since the gate electrode of the driving transistor TR_{D} is in a floating state and the capacitive element C₁ exists, a boot strap operation occurs with the gate electrode of the driving transistor TR_{D}. Accordingly, the potential at the first node ND₁ rises following up the potential variation of the second node ND₂.

As a prerequisite for the period TP(2)₅, it is necessary for the potential V₄ at the second node ND₂ to be lower than the difference V_{Ofs}−Vₜₕ at the start timing of the period TP(2)₅. The length from the start timing of the period TP(2)_{1B} to the start timing of the period TP(2)₅ is determined so as to satisfy a condition of V₄<V_{Ofs-L}−Vₜₕ.

### Period TP(2)₅ (Refer to FIGS. 7 and 9B)

Operation within the period TP(2)₅ is basically similar to that within the period TP(2)₃ described hereinabove. At the start timing of the period TP(2)₅, the voltage of the data line DTLₙ is changed over from the video signal V_{Sig}_{_{—}}ₘ₋₁ to the first node initializing voltage V_{Ofs}. At the start timing of the period TP(2)₅, the writing transistor TR_{W} is placed into an on state with a signal from the mth scanning line SCLₘ.

The first node ND₁ is placed into a state wherein the first node initializing voltage V_{Ofs} is applied thereto from the data line DTLₙ through the writing transistor TR_{W}. Further, since the driving voltage V_{CC-H} is applied from the power supply section 100 to the first one of the source/drain regions of the driving transistor TR_{D}, the potential at the second node ND₂ varies toward a potential calculated by subtracting the threshold voltage Vₜₕ of the driving transistor TR_{D} from the potential at the first node ND₁ similarly as in the period TP(2)₃ described hereinabove. Then, when the potential difference between the gate electrode and the second one of the source/drain regions of the driving transistor TR_{D} becomes equal to the threshold voltage Vₜₕ, the driving transistor TR_{D} is placed into an off state. In this state, the potential at the second node ND₂ is substantially equal to the difference V_{Ofs}−Vₜₕ. Here, if an expression (2) given below is assured, or in other words, if the potentials are selected and determined so as to satisfy the expression (2), then the light emitting element ELP does not emit light.

(V_{Ofs}−Vₜₕ)<(V_{th-EL}+V_{Cat}) (2)

Within this period TP(2)₅, the potential at the second node ND₂ finally becomes equal to the difference V_{Ofs}−Vₜₕ. In other words, the potential at the second node ND₂ relies only upon the threshold voltage Vₜₕ of the driving transistor TR_{D} and the first node initializing voltage V_{Ofs} for initializing the potential at the gate electrode of the driving transistor TR_{D}. Then, the potential at the second node ND₂ is independent of the threshold voltage V_{th-EL} of the light emitting element ELP.

### Period TP(2)_{6A} (Refer to FIGS. 7 and 9C)

At the start timing of the period TP(2)_{6A}, the writing transistor TR_{W} is placed into an off state by a scanning signal from the scanning line SCLₘ. Further, the voltage to be applied to the data line DTLₙ is changed over from the first node initializing voltage V_{Ofs} to the video signal V_{Sig}_{_{—}}ₘ (video signal period). If it is assumed that the driving transistor TR_{D} has reached to an off state in the threshold voltage cancellation process, then the potential at the first node ND₁ and the second node ND₂ does not substantially vary. It is to be noted that, if the driving transistor TR_{D} has not reached an off state in the threshold voltage cancellation process carried out within the period TP(2)₅, then a bootstrap operation occurs within the period TP(2)_{6A} and the potential at the first node ND₁ and the second node ND₂ rises a little.

### Period TP(2)_{6B} (Refer to FIGS. 7 and 9D)

Within this period, a writing process is carried out. The writing transistor TR_{W} is placed into an on state with a scanning signal from the mth scanning line SCLₘ. Then, the video signal V_{Sig}_{_{—}}ₘ is applied from the data line DTLₙ to the first node ND₁ through the writing transistor TR_{W}. As a result, the potential at the first node ND₁ rises to the video signal V_{Sig}_{_{—}}ₘ. The driving transistor TR_{D} is in an on state. It is to be noted that, under certain circumstances, it is possible to adopt another configuration wherein the on state of the writing transistor TR_{W} is maintained within the period TP(2)_{6A}. In this configuration, the writing process is started immediately after the voltage on the data line DTLₙ changes over from the first node initializing voltage V_{Ofs} to the video signal V_{Sig}_{_{—}}ₘ within the period TP(2)_{6A}. This similarly applies also to the embodiments hereinafter described.

Here, the value of the capacitive element C₁ is represented by c₁ and the value of the capacitance C_{EL} of the light emitting element ELP is represented by c_{EL}. Further, the parasitic capacitance between the gate electrode of the driving transistor TR_{D} and the second one of the source/drain regions is represented by c_{gs}. If the capacitance value between the first node ND₁ and the second node ND₂ is represented by reference character c_{A}, then c_{A}=c₁+c_{gs}. Further, if the capacitance value between the second node ND₂ and the second feeder line PS2 is represented by reference character c_{B}, then c_{B}=c_{EL}. It is to be noted that, although an additional capacitance element may be connected in parallel to the light emitting element ELP, the capacitance value of the additional capacitance element in this instance is added to c_{B}.

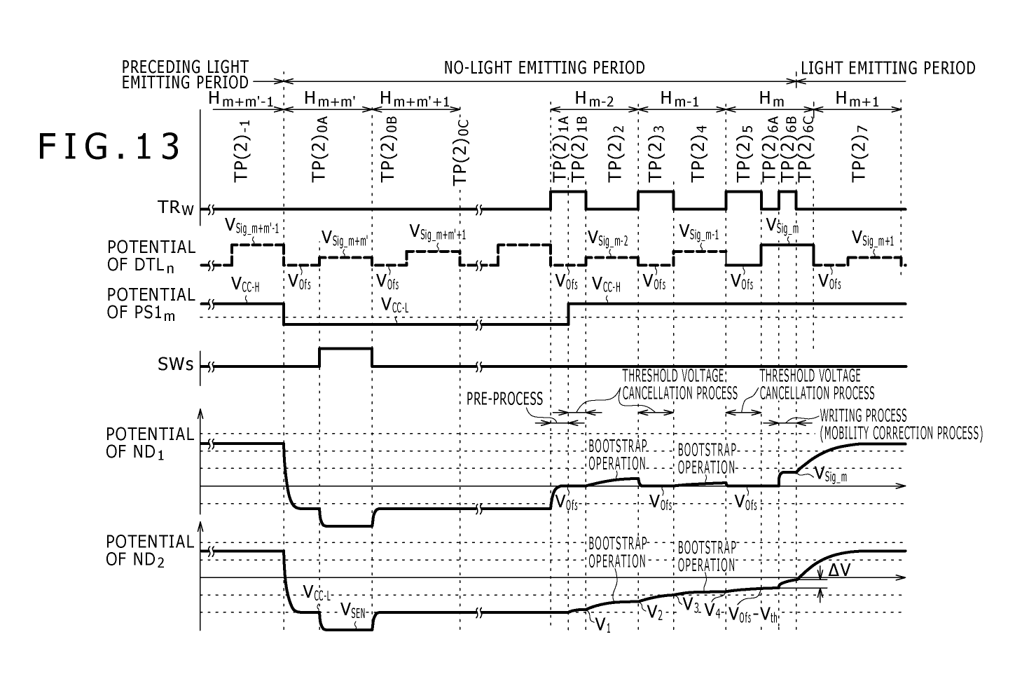

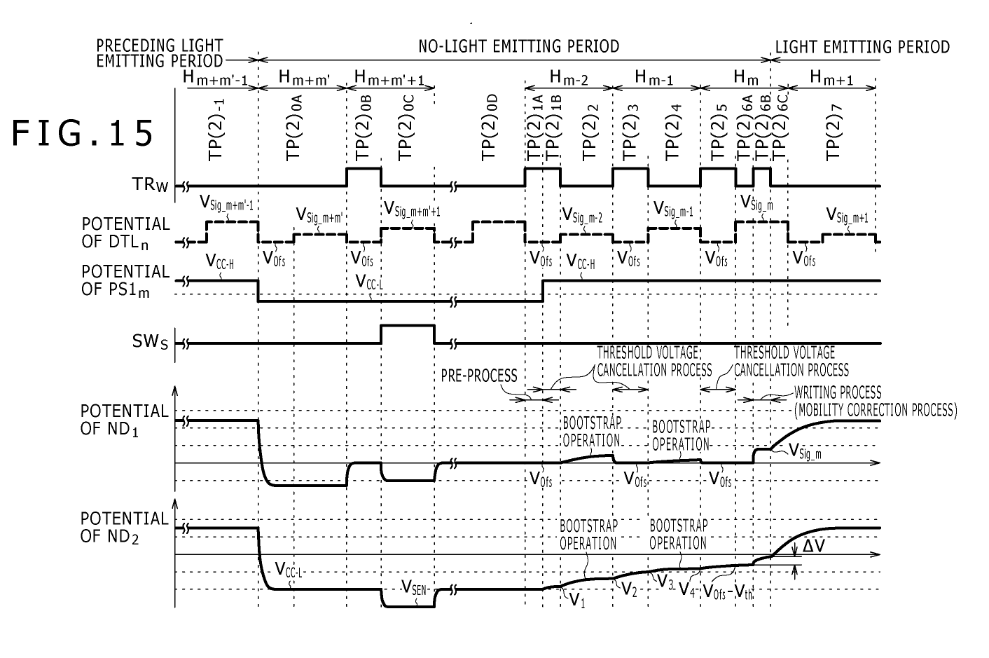

When the potential of the gate electrode of the driving transistor TR_{D} changes from V_{Ofs} to V_{Sig}_{_{—}}ₘ (>V_{Ofs}), the potential difference between the first node ND₁ and the second node ND₂ varies. In particular, the charge based on the variation amount (V_{Sig}_{_{—}}ₘ−V_{Ofs}) of the potential at the gate electrode of the driving transistor TR_{D} (=potential at the first node ND₁) is distributed in accordance with the capacitance value between the first node ND₁ and the second node ND₂ and the capacitance value between the second node ND₂ and the second feeder line PS2. However, if the value c_{B} (=c_{EL}) is sufficiently high in comparison with the value c_{A} (=c₁+c_{gs}), then the variation of the potential at the second node ND₂ is small. Generally, the value c_{EL} of the capacitance C_{EL} of the light emitting element ELP is higher than the value c₁ of the capacitive element C₁ and the value c_{gs} of the parasitic capacitance of the driving transistor TR_{D}. For the convenience of description, the following description is given without taking the potential variation of the second node ND₂ caused by the potential variation of the first node ND₁ into consideration. It is to be noted that, in the driving timing chart shown in FIG. 7, the potential variation of the second node ND₂ caused by the potential variation at the first node ND₁ is not taken into consideration. This similarly applies also to FIG. 4. Further, this similarly applies also to FIGS. 13 and 15 which are hereinafter referred to.

In the writing process described above, the video signal V_{Sig}_{_{—}}ₘ is applied to the gate electrode of the driving transistor TR_{D} in a state wherein the driving voltage V_{CC-H} is applied from the power supply section 100 to the first one of the source/drain regions of the driving transistor TR_{D}. Therefore, the potential at the second node ND₂ rises within the period TP(2)_{6B} as seen in FIG. 7. The rise amount of the potential, which is represented by ΔV in FIG. 7, is hereinafter described. Where the potential at the gate electrode of the driving transistor TR_{D}, that is, at the first node ND₁, is represented by V_{g} and the potential at the second one of the source/drain regions of the driving transistor TR_{D}, that is, at the second node ND₂, is represented by Vₛ, if the potential rise at the second node ND₂ described above is not taken into consideration, then the potential V_{g} and the potential Vₛ have such values as given below. The potential difference between the first node ND₁ and the second node ND₂, that is, the potential difference V_{gs} between the gate electrode of the driving transistor TR_{D} and the second one of the source/drain regions of the driving transistor TR_{D} which acts as the source region, can be represented by the following expression (3):

V_{g}=V_{Sig}_{_{—}}ₘ

Vₛ≈V_{Ofs}−Vₜₕ

V_{gs}≈V_{Sig}_{_{—}}ₘ−(V_{Ofs}−Vₜₕ) (3)

In other words, the potential difference V_{gs} obtained in the writing process for the driving transistor TR_{D} relies only upon the video signal V_{Sig}_{_{—}}ₘ for controlling the luminance of the light emitting element ELP, the threshold voltage Vₜₕ of the driving transistor TR_{D} and the first node initializing voltage V_{Ofs} for initializing the potential at the gate electrode of the driving transistor TR_{D}. Thus, the potential difference V_{gs} is independent of the threshold voltage V_{th-EL} of the light emitting element ELP.

Now, the rise of the potential at the second node ND₂ within the period TP(2)_{6B} described hereinabove is described. In the driving method of the reference example described above, in the writing process, a mobility correction process of raising the potential at the second one of the source/drain regions of the driving transistor TR_{D}, that is, the potential at the second node ND₂, in accordance with a characteristic of the driving transistor TR_{D} such as, for example, the magnitude of the mobility μ is carried out.

Where the driving transistor TR_{D} is formed from a polysilicon thin film transistor or a like element, it may not be avoided that a dispersion occurs in the mobility μ between transistors. Accordingly, even if a video signal V_{Sig} of an equal value is applied to the gate electrode of a plurality of driving transistors TR_{D} which are different in mobility μ from each other, a difference appears between the drain current I_{ds} flowing through a driving transistor TR_{D} having a high mobility μ and the drain current I_{ds} flowing through another driving transistor TR_{D} having a low mobility μ. Where such a difference appears, then the uniformity of the screen image of the display apparatus is damaged.

In the driving method described above, the video signal V_{Sig}_{_{—}}ₘ is applied to the gate electrode of the driving transistor TR_{D} in a state wherein the driving voltage V_{CC-H} is applied from the power supply section 100 to the first one of the source/drain regions of the driving transistor TR_{D}. Therefore, the potential at the second node ND₂ rises within the period TP(2)_{6B} as seen in FIG. 7. Where the value of the mobility μ of the driving transistor TR_{D} is high, the rise amount ΔV of, that is, the potential correction amount for, the potential at the second one of the source/drain regions of the driving transistor TR_{D}, that is, at the second node ND₂, is great. On the contrary where the value of the mobility μ of the driving transistor TR_{D} is low, the rise amount ΔV of, that is, the potential correction amount for, the potential at the second one of the source/drain regions of the driving transistor TR_{D}, is small. Here, the potential difference V_{gs} between the gate electrode and the second one of the source/drain regions, which acts as the source region, of the driving transistor TR_{D} is transformed from the expression (3) into the following expression (4):

V_{gs}≈V_{Sig}_{_{—}}ₘ−(V_{Ofs}−Vₜₕ)−ΔV (4)

It is to be noted that a predetermined time period for executing a writing process (in FIG. 7, the total time period t₀ of the period TP(2)_{6B}) may be determined in accordance with a design of the display element or the display apparatus. Further, the total time t₀ of the period TP(2)_{6B} is determined so that the potential V_{Ofs}−Vₜₕ−ΔV at the second one of the source/drain regions of the driving transistor TR_{D} at this time may satisfy the expression (2′) given below. Within the period TP(2)_{6B}, the light emitting element ELP emits no light at all. By the mobility correction process described, also correction against a dispersion in the coefficient k≡(1/2)·(W/L)·C_{OX} is carried out simultaneously.

V_{Ofs}−Vₜₕ+ΔV<V_{th-EL}+V_{Cat} (2′)

### Period TP(2)_{6C} to Period TP(2)₇ (Refer to FIGS. 7, 9E and 9F)

In a state wherein the driving voltage V_{CC-H} is kept applied from the power supply section 100 to the first one of the source/drain regions of the driving transistor TR_{D}, the mth scanning line SCLₘ is placed into a low level state and the writing transistor TR_{W} is placed into an off state and besides the first node ND₁, that is, the gate electrode of the driving transistor TR_{D}, enters a floating state by the operation of the scanning circuit 101. Accordingly, as a result of this, the potential at the second node ND₂ rises.

Here, since the gate electrode of the driving transistor TR_{D} is in a floating state and the capacitive element C₁ exists, a phenomenon similar to that which occurs with a bootstrap circuit occurs with the gate electrode of the driving transistor TR_{D}, and also the potential at the first node ND₁ rises. As a result, the potential V_{gs} between the gate electrode and the second one of the source/drain regions which acts as a source region of the driving transistor TR_{D} keeps the value of the expression (4).

Further, since the potential at the second node ND₂ rises and exceeds the value V_{th-EL}+V_{Cat}, the light emitting element ELP starts emission of light (refer to FIG. 9F). The current flowing through the light emitting element ELP at this time is the drain current I_{ds} which flows from the drain region to the source region of the driving transistor TR_{D}, and therefore, it can be represented by the expression (1). Here, from the expressions (1) and (4), the expression (1) can be transformed into the following expression (5).

I_{ds}=kμ·(V_{Sig}_{_{—}}ₘ−V_{Ofs}−ΔV)² (5)

Accordingly, if the first node initializing voltage V_{Ofs} is set, for example, to 0 volt, then the current I_{ds} flowing through the light emitting element ELP increases in proportion to the square of a value obtained by subtracting the value of the potential correction value ΔV originating from the mobility μ of the driving transistor TR_{D} from the value of the video signal V_{Sig}_{_{—}}ₘ for controlling the luminance of the light emitting element ELP. In other words, the drain current I_{ds} flowing through the light emitting element ELP does not rely upon the threshold voltage V_{th-EL} of the light emitting element ELP and the threshold voltage Vₜₕ of the driving transistor TR_{D}. In other words, the light emission amount, that is, the luminance, of the light emitting element ELP is not influenced by the threshold voltage V_{th-EL} of the light emitting element ELP nor by the threshold voltage Vₜₕ of the driving transistor TR_{D}. Then, the luminance of the (n, m)th display element 10 has a value corresponding to the drain current I_{ds}.

Besides, since the potential correction value ΔV for the driving transistor TR_{D} increases as the mobility μ increases, the value of the term V_{gs} in the left side of the expression (4) decreases. Accordingly, even if the value of the mobility μ is high, since the value of (V_{Sig}_{_{—}}ₘ−V_{Ofs}−ΔV)² in the expression (5) becomes low, the dispersion of the drain current I_{ds} originating from the dispersion of the mobility μ of the driving transistor TR_{D} and also from the dispersion of the coefficient k can be corrected. Consequently, the dispersion of the luminance of the light emitting element ELP arising from the dispersion of the mobility μ and the dispersion of the coefficient k can be corrected.

Then, the light emitting state of the light emitting element ELP continues till the (m+m′−1)th horizontal scanning period. The end timing of the (m+m′−1)th horizontal scanning period corresponds to the end timing of the period TP(2)₋₁. Here, “m′” is a predetermined value in the display apparatus which satisfies a relationship of 1<m′<M. In other words, the light emitting element ELP is driven within a period from the start timing of the period TP(2)₅ to a point of time immediately prior to the (m+m′)th horizontal scanning period H_{m+m′}, and this period is a light emitting period.

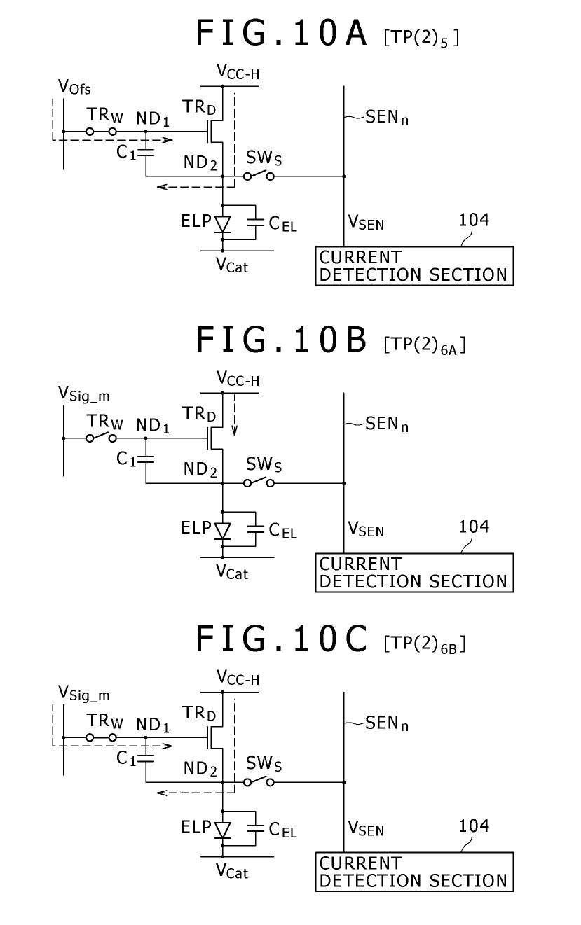

The operation of the driving method according to the reference example has been described. Now, the driving method of the embodiment 1 is described. FIGS. 10A to 10C, 11A to 11C and 12 schematically illustrate on/off states and so forth of the transistors and the switching element SWₛ which form the driving circuit 11 of the display element 10 in a process for current detection.

The driving method according to the embodiment 1 is suitable to carry out as self diagnosis of the display apparatus, for example, when the power supply is made available or in a like case. The switching element SWₛ is placed into an on state in a state wherein the potential of the current detection line SENₙ is maintained so that the potential difference between the other end of the light emitting element ELP and the current detection line SENₙ may not exceed the threshold voltage of the light emitting element ELP, and current flowing through the driving transistor TR_{D} is supplied to the current detection line SENₙ and detected.

It is to be noted that, in the driving method of the embodiment 1, the display apparatus is driven with the value of the video signal V_{Sig} fixed. For example, the video signal V_{Sig} is normally fixed to 8 volt and applied to the data line.

### Period TP(2)₀ (Refer to FIG. 4)

This period is a period, for example, immediately after the power supply is made available. For the convenience of description, it is assumed that the state then is similar to that within the period TP(2)₀ in the reference example described hereinabove with reference to FIG. 6. It is to be noted that the switching element SWₛ remains in an off state except within a period TP(2)_{7B} hereinafter described.

### Period TP(2)_{1A} to Period TP(2)₄ (Refer to FIG. 4)

Operation within the periods is similar to that within the period TP(2)_{1A} to the period TP(2)₄. Therefore, overlapping description is omitted herein to avoid redundancy.

### Period TP(2)₅ (Refer to FIGS. 4 and 10A)

Operation within this period is similar to that within the period TP(2)₅ of the reference example described hereinabove with reference to FIG. 6. If the potential difference between the gate electrode and the second one of the source/drain regions of the driving transistor TR_{D} reaches the threshold voltage Vₜₕ, then the driving transistor TR_{D} is placed into an off state. In this state, the potential at the second node ND₂ is substantially equal to V_{Ofs}−Vₜₕ.

### Period TP(2)_{6A} (Refer to FIGS. 4 and 10B)

Thereafter, within the period TP(2)_{6A}, the writing transistor TR_{W} is placed into an off state. Then, the voltage of the data line DTLₙ is set to the video signal V_{Sig}_{_{—}}ₘ which is 8 volt. At the end timing of the period TP(2)₅, if the driving transistor TR_{D} is in an off state, then the potential at the first node ND₁ and the second node ND₂ does not vary.

### Period TP(2)_{6B} (Refer to FIGS. 4 and 10C)

Similarly as in the description of the reference example, within the period TP(2)_{1A}, the step (a) described hereinabove, that is, the pre-process, is completed, and the step (b), that is, the threshold voltage cancellation process, ends over the period TP(2)_{1B} to period TP(2)₅.

Then, within this period TP(2)_{6B}, the step of

(c) applying the video signal V_{Sig}_{_{—}}ₘ, which is 8 volt, as a reference voltage to the first node ND₁, is carried out. It is to be noted that, in the embodiment 1, the step (c) is carried out in a state wherein the driving voltage V_{CC-H} is applied to the first one of the source/drain regions of the driving transistor TR_{D} through the feeder line PS1ₘ.

The operation within this period is similar to that within the period TP(2)_{6B} of the reference example described hereinabove with reference to FIG. 6 except that the video signal V_{Sig} is fixed, and therefore, description of the operation is omitted here to avoid redundancy. The potential difference V_{gs} between the gate electrode and the second one of the source/drain regions of the driving transistor TR_{D} is given by the expression (4) specified hereinabove.

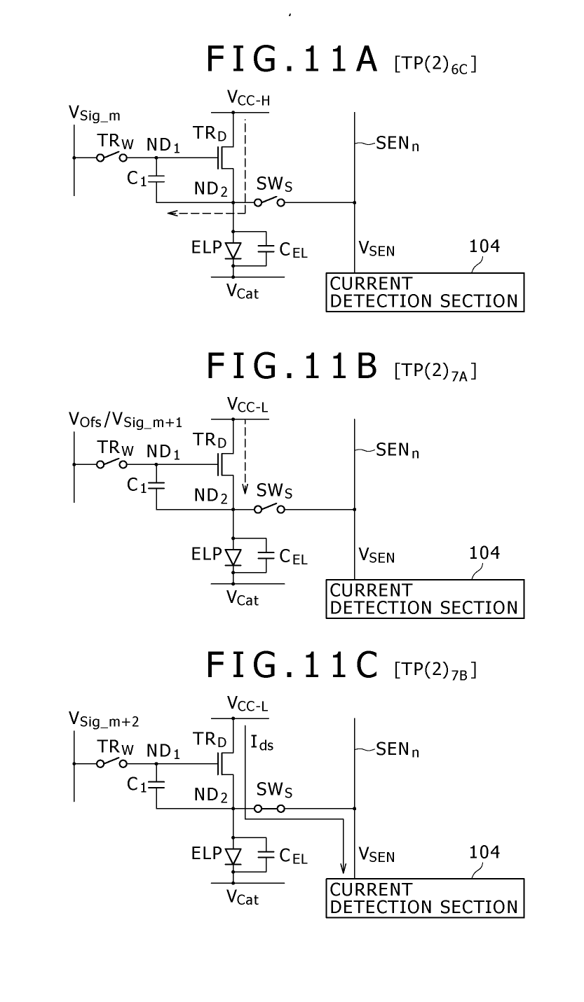

### Period TP(2)_{6C} (Refer to FIGS. 4 and 11A)

Operation within this period is similar to that within the period TP(2)_{6C} of the reference example described hereinabove with reference to FIG. 6. In a state wherein the state wherein the driving voltage V_{CC-H} is applied from the power supply section 100 to the first one of the source/drain regions of the driving transistor TR_{D} is maintained, the mth scanning line SCLₘ is placed into a low level state to place the writing transistor TR_{W} into an off state to place the first node ND₁, that is, the gate electrode of the driving transistor TR_{D}, into a floating state by operation of the scanning circuit 101. The potential at the first node ND₁ and the second node ND₂ rises.

It is to be noted that the period TP(2)_{6C} is such a short period as a fraction of one horizontal scanning period. Accordingly, the rise of the potential at the second node ND₂ within this period is not very great. If the potential at the second node ND₂ does not exceed the sum voltage V_{th-EL}+V_{Cat}, then the light emitting element ELP does not emit light.

### Period TP(2)_{7A} (Refer to FIGS. 4 and 11B)

The start timing of this period corresponds to the start timing of the (m+1)th horizontal scanning period Hₘ₊₁. At the start timing of this period, the voltage to be supplied from the power supply section 100 to the feeder line PS1ₘ is changed over from the driving voltage V_{CC-H} to the second node initializing voltage V_{CC-L}. As a result, the potential at the second node ND₂ drops down to the second node initializing voltage V_{CC-L}, and a reverse direction voltage is applied between the anode electrode and the cathode electrode of the light emitting element ELP. Also the potential at the first node ND₁ in a floating state, that is, at the gate electrode of the driving transistor TR_{D}, drops in such a manner as to follow up the potential drop of the second node ND₂.

### Period TP(2)_{7B} (Refer to FIGS. 4 and 11C)

This period corresponds to a video signal period within the (m+2)th horizontal scanning period Hₘ₊₂. At the start timing of this period, the switching element SWₛ is placed into an on state to electrically connect the second node ND₂ and the current detection line SENₙ to each other.

As a result, the potential at the second node ND₂ becomes equal to the voltage V_{SEN}, which is −15 volt. The second node initializing voltage V_{CC-L}, which is −10 volt is applied to the first one of the source/drain regions of the driving transistor TR_{D}. Since the potential difference V_{gs} between the gate electrode and the second one of the source/drain regions of the driving transistor TR_{D} maintains a value given by the expression (4) specified hereinabove, the drain current I_{ds} given by the expression (5) given hereinabove flows to the driving transistor TR_{D}.

Then, the potential difference between the anode electrode and the cathode electrode of the light emitting element ELP does not exceed the threshold voltage V_{th-EL} of the light emitting element ELP. Accordingly, it is possible to allow the drain current I_{ds} flowing through the driving transistor TR_{D} to flow to the current detection line SENₙ so that it is detected through the current detection line SENₙ.

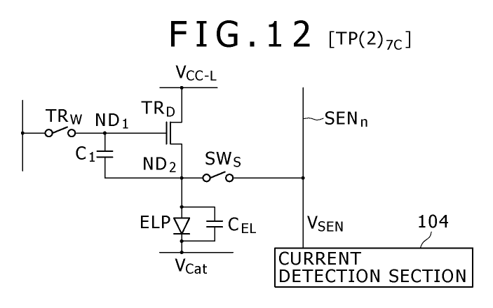

### Period TP(2)_{7C} (Refer to FIGS. 4 and 12)

This period corresponds to a period later than the (m+3)th horizontal scanning period Hₘ₊₃. At the start timing of this period, the switching element SWₛ is placed into an off state. Since the second node initialization voltage V_{CC-L} is supplied to the feeder line PS1_{D}, the potential at the second node ND₂ returns to the second node initializing voltage V_{CC-L}. Also the potential at the first node ND₁ in a floating state, that is, at the gate electrode of the driving transistor TR_{D}, returns following up the potential variation at the second node ND₂.

By carrying out the operations described above line-sequentially, the drain current flowing through the driving transistor TR_{D} which forms the display element 10 flows to the current detection line SENₙ for every horizontal scanning period as seen in FIG. 5. In the embodiment 1, the drain current under the condition that the threshold voltage cancellation process and the mobility correction process are carried out while the video signal V_{Sig} is kept at a fixed value can be detected.

Then, the current detection section 104 outputs a signal in response to the current flowing through the current detection line SENₙ and sends the signal to the signal controlling section 105. The signal controlling section 105 carries out control of adjusting the magnitude of the video signal in response to the signal from the current detection section 104.

The current detection section 104 includes storage means not shown in which reference values for the drain current to flow to the driving transistor TR_{D} of the display elements 10 are stored. Each reference value is a drain current value upon shipment inspection of the display apparatus, for example, when the video signal has a fixed value, which is 8 volts in the embodiment 1. The current detection section 104 compares the value of current flowing through the current detection line SENₙ and the reference value described above and outputs a signal whose value corresponds to a degree of relative variation with respect to the reference value.

The signal controlling section 105 is formed from a multiplication circuit for the video signal in the form of a digital value prior to D/A conversion. The signal controlling section 105 includes storage means not shown in which a parameter for multiplication corresponding to each display element 10 is stored. The signal controlling section 105 corrects the parameter for multiplication corresponding to the pertaining display element 10 based on the signal from the current detection section 104. In particular, if the drain current exhibits decrease with a certain display element 10, then the parameter for multiplication should be increased so as to compensate for the decreasing amount of the drain current for the display element 10. By carrying out the operation just described for all display elements 10, a good image display characteristic can be maintained. It is to be noted that, after the operation described above is carried out, the video signal V_{Sig} can assume a value higher than 8 volt.

As described hereinabove, the driving method in the embodiment 1 can be carried out as self diagnosis of the display apparatus, for example, when the power supply is made available. After the parameter for multiplication described above is set for all display elements 10, operation similar to that described above in connection with the reference example should be carried out to display an image in a state wherein the switching element SWₛ is kept in an off state.

### 4. Embodiment 2

Also the embodiment 2 relates to a display apparatus and a driving method for the display apparatus of the embodiments of the present invention. In the embodiment 2, drain current flowing through a driving transistor can be detected in a state wherein an image is displayed on the display apparatus.

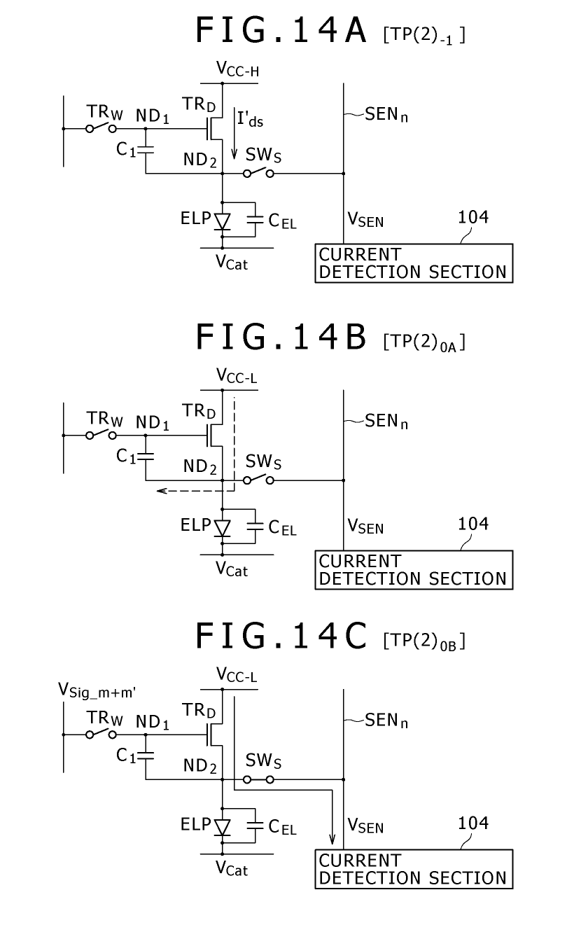

The configuration of the display apparatus used in the present embodiment 2 is basically similar to that of the display apparatus described hereinabove in connection with the embodiment 1, and also the values of various voltages or potentials are similar to those used in the embodiment 1. Therefore, description of them is omitted herein to avoid redundancy. A timing chart of operation according to the driving method for the display apparatus in the embodiment 2 is shown in FIG. 13. FIGS. 14A to 14C schematically illustrate on/off states and so forth of the transistors which form the driving circuit 11 of the display element 10 and the switching element SWₛ and illustrate a current detection step.

In the embodiment 1 described hereinabove, the video signal V_{Sig}_{_{—}}ₘ/which is 8 volt, as a reference voltage is applied from the data line DTLₙ to the first node ND₁ to carry out the step (c) within the period TP(2)_{6B} shown in FIG. 4. In contrast, in the embodiment 2, the step (c) is replaced by steps of

(c-1) carrying out a writing process of applying the video signal V_{Sig} from the data line DTLₙ to the first node ND₁ through the writing transistor TR_{W} which has been placed into an on state with a scanning signal from the scanning line SCLₘ, and

(c-2) placing the writing transistor TR_{W} into an off state with the scanning signal from the scanning line SCLₘ to place the first node ND₁ into a flowing state and supplying, in a state wherein the driving voltage V_{CC-H} is applied from the feeder line PS1ₘ to the first one of the source/drain regions of the driving transistor TR_{D}, current corresponding to the value of the potential difference between the first node ND₁ and the second node ND₂ to the light emitting element ELP through the driving transistor TR_{D}.

It is to be noted that, in the present embodiment 2, the step (c-1) is carried out in a state wherein the driving voltage V_{CC-H} is supplied to the first one of the source/drain regions of the driving transistor TR_{D} through the feeder line PS1ₘ.

As operation in the embodiment 2, operation similar to that of the driving method of the reference example described hereinabove in connection with the embodiment 1 with reference to FIG. 7 is carried out and the switching element SWₛ is placed into an on state to detect current within a period within which a video signal V_{Sig}_{_{—}}_{m+m′} is applied to the data line. The switching element SWₛ remains in an off state except a period TP(2)_{0B} hereinafter described.

### Period TP(2)_{0C} to Period TP(2)₇ (Refer to FIG. 13)

Operation within the periods is substantially similar to that in the driving method of the reference example described hereinabove with reference to FIG. 7, and therefore, overlapping description of the same is omitted herein to avoid redundancy. A current detection step is carried out within and after the period TP(2)₇. For the convenience of description, the current detection step in the preceding display frame is described with the assumption that the operation within the period TP(2)_{0C} to period TP(2)_{6C} for the preceding display frame is completed and the period TP(2)₇ in the preceding display frame is represented as a period TP(2)₋₁ illustrated in FIG. 13. This similarly applies also to the embodiment 3 hereinafter described.

### Period TP(2)₋₁ (Refer to FIGS. 13 and 14A)

Drain current I′_{ds} based on the expression (5′) given hereinabove flows through the light emitting element ELP of the display element 10 which forms the (n, m)th sub pixel, and the luminance of the display element 10 which forms the (n, m)th sub pixel exhibits a value corresponding to the drain current I′_{ds}.

### Period TP(2)_{0A} (Refer to FIGS. 13 and 14B)

Operation within this period is similar to that within the period TP(2)₀ of the reference example described hereinabove in connection with the embodiment 1 with reference to FIG. 7. The voltage to be supplied from the power supply section 100 to the feeder line PS1ₘ is changed over from the driving voltage V_{CC-H} to the second node initialization voltage V_{CC-L}. As a result, the potential at the second node ND₂ drops to the second node initializing voltage V_{CC-L}, and a reverse direction voltage is applied between the anode electrode and the cathode electrode of the light emitting element ELP thereby to place the light emitting element ELP into a no-light emitting state. Also the potential at the first node ND₁ in a floating state, that is, at the gate electrode of the driving transistor TR_{D}, drops following up the potential drop at the second node ND₂.

### Period TP(2)_{0B} (Refer to FIGS. 13 and 14C)

Within this period, the switching element SWₛ is placed into an on state. As a result, the potential at the second node ND₂ becomes equal to the voltage V_{SEN}, which is −15 volt. The second node initializing voltage V_{CC-L}, which is −10 volt, is applied to the first one of the source/drain regions of the driving transistor TR_{D}. Since the potential difference V_{gs} between the gate electrode and the second one of the source/drain regions of the driving transistor TR_{D} is maintained by the capacitive element, drain current I_{ds}′ given by the expression (5′) flows to the driving transistor TR_{D}.

The potential difference between the anode electrode and the cathode electrode of the light emitting element ELP does not exceed the threshold voltage V_{th-EL} of the light emitting element ELP. Accordingly, the drain current I_{ds}′ flowing through the driving transistor TR_{D} can be supplied to the current detection line SENₙ so as to be detected. In this manner, the present embodiment 2 is advantageous in that current of a value equal to that of the drain current which has been flowed through the light emitting element ELP can be detected.

Operation of the current detection section 104 is basically similar to that described hereinabove in connection with the embodiment 1, and therefore, overlapping description of the same is omitted herein to avoid redundancy. However, in the embodiment 2, the current to be detected varies in response to the value of the video signal V_{Sig}. Accordingly, it is necessary to prepare a plurality of different reference values corresponding to individual values of the video signal V_{Sig}. Further, upon comparison between a current value and a reference value, it is necessary to select a reference value corresponding to the value of the video signal V_{Sig} and use the selected reference value for comparison, and it becomes necessary for the current detection section 104 to operate referring also to the value of the video signal V_{Sig}.

### 5. Embodiment 3

Also the embodiment 3 relates to a display apparatus and a driving method for the display apparatus according to the embodiment of the present invention. The embodiment 3 is a modification to the embodiment 2.

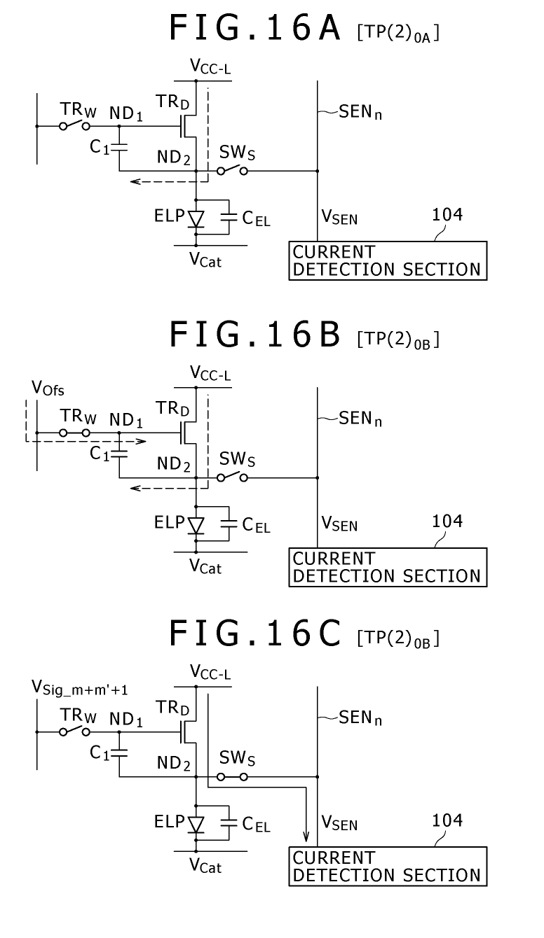

The configuration of the display apparatus used in the present embodiment 3 is basically similar to that of the display apparatus described hereinabove in connection with the embodiment 1, and also the values of various voltages or potentials are similar to those used in the embodiment 1. Therefore, description of them is omitted herein to avoid redundancy. A timing chart of operation according to the driving method for the display apparatus in the embodiment 3 is shown in FIG. 15. FIGS. 16A to 16C schematically illustrate on/off states and so forth of the transistors which form the driving circuit 11 of the display element 10 and the switching element SWₛ.

The embodiment 3 is different from the embodiment 2 described hereinabove in that the step (c-2) described hereinabove is followed by a step of

(c-3) setting the potential for the first node ND₁ and the potential for the second node ND₂ so that the potential difference between the first node ND₁ and the second node ND₂ may have a fixed value.

In the embodiment 3, the first node initializing voltage V_{Ofs} is applied from the data line DTL to the first node ND₁ through the writing transistor TR_{W} which has been placed into an on state with the scanning signal from the scanning line SCLₘ while the second node initializing voltage V_{CC-L} is applied from the feeder line PS1ₘ to the second node ND₂ through the driving transistor TR_{D} to set the potential at the first node ND₁ and the potential at the second node ND₂, respectively.

In the embodiment 2, current having a value equal to that of drain current flowing to the light emitting element ELP in a state wherein an image is displayed actually is detected. Accordingly, when a current value and a reference value are to be compared with each other, it is necessary to prepare a plurality of different reference values corresponding to different values of the video signal. However, in the embodiment 3, the current detection step is carried out after the potential difference between the first node ND₁ and the second node ND₂ is set to a fixed value. Therefore, there is no necessity to prepare a plurality of different reference values corresponding to different values of the video signal. In the following, operation of the embodiment 3 is described.

### Period TP(2)₋₁ (Refer to FIG. 15)

Operation within this period is similar to that within the period TP(2)₋₁ in the embodiment 2, and therefore, overlapping description of the same is omitted herein to avoid redundancy.

### Period TP(2)_{0A} (Refer to FIGS. 15 and 16A)

Operation within this period is substantially similar to that within the period TP(2)_{0A} in the embodiment 2. However, operation of the embodiment 3 is different from that of the embodiment 2 in that the end timing of this period is the end timing of the (m+m′)th horizontal scanning period H_{m+m′}. The potential at the second node ND₂ drops down to the second node initializing voltage V_{CC-L} and a reverse voltage is applied between the anode electrode and the cathode electrode of the light emitting element ELP so that the light emitting element ELP is placed into a no-light emitting state. Also the potential at the first node ND₁ in a floating state, that is, at the gate electrode of the driving transistor TR_{D}, drops in such a manner as to follow up the potential drop at the second node ND₂.

### Period TP(2)_{0B} (Refer to FIGS. 15 and 16B)

Within this period, the step (c-3) described above is carried out. This period is an initialization period within the (m+m′+1)th horizontal scanning period H_{m+m′+1}, and the voltage of the data line DTLₙ is the first node initialization voltage V_{Ofs}. The writing transistor TR_{W} is placed into an on state based on the scanning signal from the scanning line SCLₘ. Then, the first node initialization voltage V_{Ofs} is applied as a reference voltage to the first node ND₁.

Consequently, the potential at the first node ND₁ becomes equal to the first node initialization voltage V_{Ofs}. On the other hand, the potential at the second node ND₂ is the second node initializing voltage V_{CC-L}. Accordingly, the difference voltage V_{Ofs}−V_{CC-L} is retained in the capacitive element C₁.

### Period TP(2)_{0C} (Refer to FIGS. 15 and 16C)

Within this period, the current detection step is carried out. This period is a video signal period within the horizontal scanning period H_{m+m′+1}. Within this period, the switching element SWₛ is placed into an on state. As a result, the potential at the second node ND₂ becomes equal to the voltage V_{SEN}, which is −15 volt. The second node initializing voltage V_{CC-L}, which is −10 volt, is applied to the first one of the source/drain regions of the driving transistor TR_{D}.

The potential difference V_{gs} between the gate electrode and the second one of the source/drain regions of the driving transistor TR_{D} is V_{Ofs}−V_{CC-L}. The drain current I_{ds}″ given by the following expression (6) flows to the driving transistor TR_{D}:

I_{ds}″=k·μ·(V_{Ofs}−V_{CC-L}Vₜₕ)² (6)

The potential difference between the anode electrode and the cathode electrode of the light emitting element ELP does not exceed the threshold voltage V_{th-EL} of the light emitting element ELP. Accordingly, it is possible to supply the drain current I_{ds}″ flowing through the driving transistor TR_{D} to the current detection line SENₙ so as to be detected. In this manner, different from the embodiment 2, in the embodiment 3, the drain current to be detected is not influenced by the value of the video signal V_{Sig}.

Operation of the current detection section 104 is basically similar to that described hereinabove in connection with the embodiment 1, and therefore, overlapping description of the same is omitted herein to avoid redundancy. Different from the embodiment 2, the current to be detected is not influenced by the value of the video signal. Accordingly, the embodiment 3 is advantageous in that it is not necessary to prepare a plurality of different reference values corresponding to different values of the video signal as in the embodiment 2.

While the present invention has been described in connection with the preferred embodiments thereof, the present invention is not limited to the specific embodiments. The configuration and structure of the display apparatus and the display elements and the steps of the driving methods for the display apparatus described in connection with the embodiments of the present invention are merely illustrative and can be modified suitably.

In the description of the embodiments, it is described that the driving transistor is of the n-channel type. Where a transistor of the p-channel type is used alternatively for the driving transistor, the connection scheme should be modified such that the anode electrode and the cathode electrode of the light emitting element are exchanged. It is to be noted that, since the direction in which drain current flows changes, it is necessary to suitably change the value of the voltage to be applied to the display element or the current detection line.

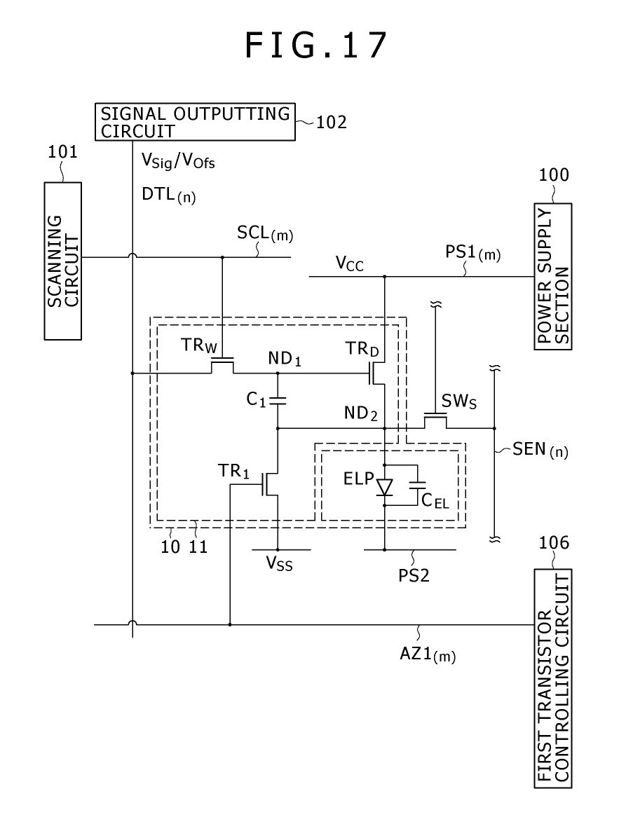

The driving circuit which forms the display element may be configured otherwise such that, for example, as shown in FIG. 17, a driving circuit 11 which forms a display element 10 includes a transistor, that is, the first transistor TR₁, connected to the second node ND₂. In the first transistor TR₁, a first one of the source/drain regions receives a second node initializing voltage V_{SS} supplied thereto, and a second one of the source/drain regions is connected to the second node ND₂. A signal from a first transistor controlling circuit 106 is applied to the gate electrode of the first transistor TR₁ through a first transistor control line AZ1 to control the first transistor TR₁ between on and off states. Consequently, a potential of the second node ND₂ can be set. It is to be noted that, in FIG. 17 and FIGS. 18 and 19 hereinafter described, a control line CTL, the current detection controlling circuit 103 and so forth are omitted.

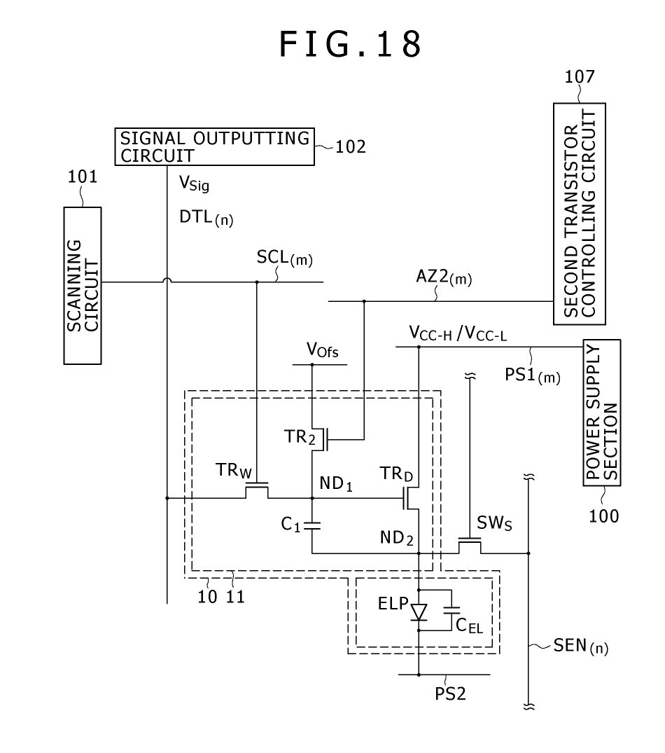

Or, the driving circuit 11 which forms the display element 10 may otherwise be configured such that it includes a transistor, that is, a second transistor TR₂, connected to the first node ND₁ as shown in FIG. 18. In the second transistor TR₂, a first one of the source/drain regions is connected to receive the first node initializing voltage V_{Ofs} applied thereto, and a second one of the source/drain regions is connected to the first node ND₁. A signal from the signal controlling section 105 is applied to the gate electrode of the second transistor TR₂ through a second transistor control line AZ2 to control the second transistor TR₂ between on and off states. The potential at the first node ND₁ can be set thereby.

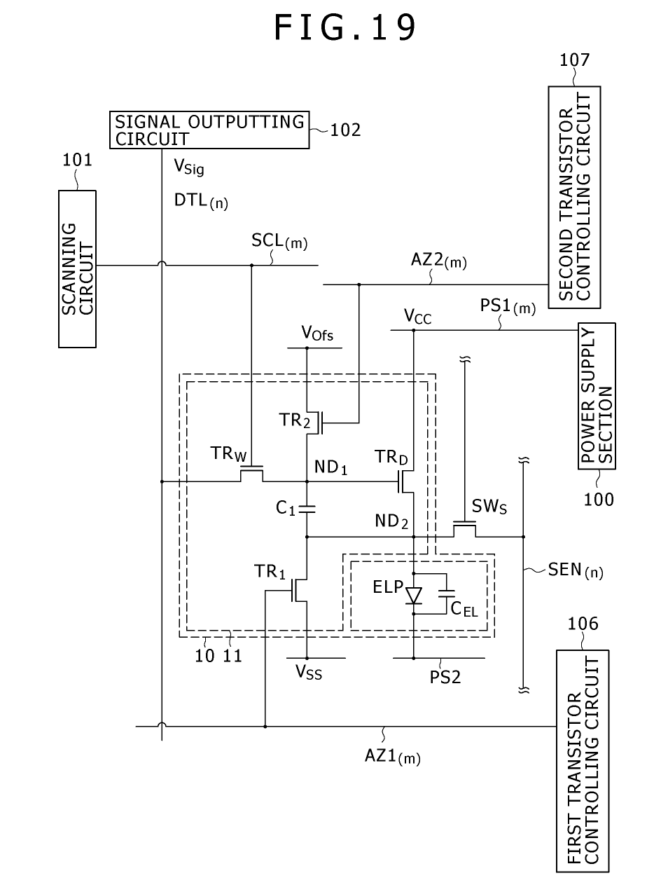

Further, the driving circuit 11 which forms the display element 10 may otherwise be configured such that it includes both of the first transistor TR₁ and the second transistor TR₂ described hereinabove as seen in FIG. 19. Also it is possible for the driving circuit 11 to have a further configuration which includes a different additional transistor.

The present application contains subject matter related to that disclosed in Japanese Priority Patent Application JP 2009-090076 filed in the Japan Patent Office on Apr. 2, 2009, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. A driving method for a display apparatus which includes:
(1) a scanning line connected to a scanning circuit and extending in a first direction;
(2) a data line connected to a signal outputting circuit and extending in a second direction;
(3) a display element including a current-driven type light emitting element and a driving circuit; and
(4) a feeder line connected to a power supply section and extending in the first direction;
the driving circuit which composes the display element including a writing transistor, a driving transistor and a capacitive element;
the driving transistor being configured such that
(A-1) a first one of source/drain regions is connected to the feeder line; that
(A-2) a second one of the source/drain regions is connected to an end of the light emitting element and also to a first one of electrodes of the capacitive element and forms a second node; and that
(A-3) the gate electrode is connected to the second one of the source/drain regions of the writing transistor and also to a second one of the electrodes of the capacitive element and forms a first node;
the writing transistor being configured such that
(B-1) a first one of source/drain regions is connected to the data line; and that
(B-2) the gate electrode is connected to the scanning line;
the display apparatus further including
(5) a current detection line extending in the second direction, and
(6) a switching element disposed between the second node and the current detection line,
said driving method for a display apparatus comprising the step of
placing the switching element into an on state in a state wherein a potential of the current detection line is maintained so that a potential difference between the second end of the light emitting element and the current detection line does not exceed a threshold voltage of the light emitting element and supplying current flowing through the driving transistor to the current detection line so as to be detected.

2. The driving method for a display apparatus according to claim 1, further comprising the steps of:
(a) carrying out a pre-process for initializing a potential at the first node and a potential at the second node so that a potential difference between the first node and the second node exceeds a threshold voltage of the driving transistor and a potential difference between the second node and the second end of the light emitting element does not exceed the threshold voltage of the light emitting element;
(b) carrying out a threshold voltage cancellation process for varying the potential at the second node toward a potential calculated by subtracting the threshold voltage of the driving transistor from the potential at the first node in a state wherein the potential at the first node is maintained; and
(c) applying a reference voltage to the first node;
the current detection step being carried out after the step (c).

3. The driving method for a display apparatus according to claim 2, comprising, in place of the step (c), the steps of:
(c-1) carrying out a writing process for applying a video signal from the data line to the first node through the writing transistor which has been placed into an on state based on a scanning signal from the scanning line; and
(c-2) placing the writing transistor into an off state based on the scanning signal from the scanning line to place the first node into a floating state and supplying current corresponding to a value of the potential difference between the first node and the second node to the light emitting element through the driving transistor in a state wherein the driving voltage is applied from the feeder line to the first one of the source/drain regions of the driving transistor.

4. The driving method for a display apparatus according to claim 3, further comprising, next to the step (c-2), the step of:
(c-3) setting the potential for the first node and the potential for the second node so that the potential difference between the first node and the second node may have a fixed value.

5. The driving method for a display apparatus according to claim 1, further comprising the step of
controlling a value of a video signal to be applied to the data line based on a value of the current detected at the current detection step.

6. A display apparatus, comprising:
(1) a scanning line connected to a scanning circuit and extending in a first direction;
(2) a data line connected to a signal outputting circuit and extending in a second direction;
(3) a display element including a current-driven type light emitting element and a driving circuit;
(4) a feeder line connected to a power supply section and extending in the first direction;
said driving circuit which composes said display element including a writing transistor, a driving transistor and a capacitive element;
said driving transistor being configured such that
(A-1) a first one of source/drain regions is connected to said feeder line; that
(A-2) a second one of said source/drain regions is connected to an end of said light emitting element and also to a first one of electrodes of said capacitive element and forms a second node; and that
(A-3) said gate electrode is connected to said second one of said source/drain regions of said writing transistor and also to a second one of said electrodes of said capacitive element and forms a first node;
said writing transistor being configured such that
(B-1) a first one of source/drain regions is connected to said data line; and that
(B-2) said gate electrode is connected to said scanning line;
(5) a current detection line extending in said second direction; and
(6) a switching element disposed between said second node and said current detection line.

7. The display apparatus according to claim 6, wherein a voltage which satisfies a condition that, when said current detection line and said second node are electrically connected to each other by said switching means placed in an on state, a potential difference between an anode electrode and a cathode electrode provided on said light emitting element does not exceed a threshold voltage of said light emitting element is applied to said current detection line.

8. The display apparatus according to claim 6, further comprising:
(7) a current detection section adapted to output a signal in response to a value of current flowing through said current detection line; and
(8) a signal controlling section configured to control a value of a video signal supplied from said signal outputting circuit;
said signal controlling section being controlled in response to the signal from said current detection section.
